(19) United States
(12) Patent Application Publication
(10) Pub. No.: US 2005/0002827 A1
(43) Pub. Date: Jan. 6, 2005

(54) Optical discs including equi-radial and/or spiral analysis zones and related disc drive systems and methods

(76) Inventors: Kevin Robert McIntyre, Irvine, CA (US); James Howard Coombs, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/347,155

(22) Filed: Jan. 15, 2003

Related U.S. Application Data
(60) Provisional application No. 60/353,014, filed on Jan. 29, 2002.

(51) Int. Cl. B32B 5/02; G01N 21/29

(52) U.S. Cl. 422/82.05; 422/164; 422/165

(57) ABSTRACT

An optical analysis disc includes a substrate having an inner perimeter and an outer perimeter and an operational layer associated with the substrate. The operational layer includes encoded information located substantially along information tracks. An analysis area includes investigational features. The analysis area is positioned between the inner perimeter and the outer perimeter of the substrate and directed along the information tracks so that when an incident beam of electromagnetic energy tracks along the information tracks, any investigational features within the analysis zone are thereby interrogated circumferentially.

### CROSS-REFERENCE TO RELATED APPLICATIONS

This application claims the benefit of priority from U.S. Provisional Application Ser. No. 60/353,014 filed Jan. 29, 2002 which is herein incorporated by reference in its entirety.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates in general to optical discs, optical disc drives and optical disc interrogation methods and, in particular, to alternative configurations for the analysis zones of an optical bio-disc. More specifically, but without restriction to the particular embodiments hereinafter described in accordance with the best mode of practice, this invention relates to optical discs including equi-radial and/or spiral analysis zones and to related disc drive systems and methods. For the purposes of convenience, the terms equi-radial, e-radial, e-rad, and eRad may be utilized herein interchangeably.

2. Discussion of the Background Art

The Optical Bio-Disc, also referred to as Bio-Compact Disc (BCD), bio-optical disc, optical analysis disc or compact bio-disc, is known in the art for performing various types of bio-chemical analyses. In particular, this optical disc utilizes the laser source of an optical storage device to detect biochemical reactions on or near the operating surface of the disc itself. These reactions may be occurring in small channels inside the disc, frequently with one or more dimensions of less than 300 microns, or may be reactions occurring on the open surface of the disc. Whatever the system, multiple reaction sites are usually needed either to simultaneously detect different reactions, or to repeat the same reaction for error detection purposes.

The current positioning of these reaction sites is to have them along a single radius, i.e. at a single angular coordinate, of the disc. However, this configuration has various limitations, which are summarized in the following.

First of all, the laser head of the disc drive system has to cover the full radial extension of the disc in order to read out all the spots. This necessity implies long reading times, and in particular reading times longer than it would be needed for reading a more limited range of radii.

Furthermore, a disc drive system is required having a detector for transmitted light which must either be extended in the radial direction or move with the laser source, otherwise the laser light at a certain radial portion will not fall on the detector.

Another limitation of the current configuration of the reaction sites is that, in detection mechanisms involving cell capture at a surface, the uncaptured cells move over all other capture regions during disc rotation, and may disturb reactions at these locations. In addition, the cells must move a large distance, typically up to 40 mm, in order to be away from the radially-arranged detection regions.

Moreover, the variation of centripetal force with radius may introduce variations in the capture probability, distribution, or concentrations of cells or beads.

A still further limitation is that the outer radial portion of a channel of the disc is near the outer edge of the disc itself, leading to the possibility that there may be leakage from the channel out of the disc.

### SUMMARY OF THE INVENTION

It is an object of the present invention to overcome limitations in the known art.

Accordingly, the present invention is directed to alternative configurations for the analysis zones of an optical bio-disc, and to related disc drive systems and methods.

More specifically, the present invention is directed to an optical analysis bio-disc. The disc may advantageously include a substrate having an inner perimeter and an outer perimeter; an operational layer associated with the substrate and including encoded information located along information tracks; and an analysis area including investigational features. The analysis area is positioned between the inner perimeter and the outer perimeter and is directed along the information tracks so that when an incident beam of electromagnetic energy tracks along them, the investigational features within the analysis area are thereby interrogated circumferentially.

The present invention is also directed to an optical analysis disc as defined above, wherein when an incident beam of electromagnetic energy tracks along the information tracks, the investigational features within the analysis area are thereby interrogated according to a spiral path or, in general, according to a path of varying angular coordinate.

Preferably, the substrate includes a series of substantially circular information tracks that increase in circumference as a function of radius extending from the inner perimeter to the outer perimeter, the analysis area is circumferentially elongated between a pre-selected number of circular information tracks and the investigational features are interrogated substantially along the circular information tracks between a pre-selected inner and outer circumference.

According to a preferred embodiment, the analysis area includes a fluid chamber. Preferably, rotation of the bio-disc distributes investigational features in a substantially consistent distribution along the analysis area and/or in a substantially even distribution along the analysis area.

The present invention is further directed to an optical analysis bio-disc. In this embodiment, the bio-disc includes a substrate having an inner perimeter and an outer perimeter; and an analysis zone including investigational features, the analysis zone being positioned between the inner perimeter and the outer perimeter of the substrate and extending according to a varying angular coordinate, and preferably according to a substantially circumferential or spiral path.

Preferably, the analysis zone extends according to a varying angular and radial coordinate. In an alternative embodiment, the analysis zone extends according to a varying angular coordinate and at a substantially fixed radial coordinate.

Preferably, the disc comprises an operational layer associated with the substrate and including encoded information located substantially along information tracks.

According to another preferred embodiment, the substrate includes a series of information tracks, preferably of a substantially circular profile and increasing in circumference as a function of radius extending from the inner perimeter to the outer perimeter, and the analysis zone is directed substantially along the information tracks, so that when an incident beam of electromagnetic energy tracks along the information tracks, the investigational features within the analysis zone are thereby interrogated circumferentially. More preferably, the analysis zone is circumferentially elongated between a pre-selected number of circular information tracks, and the investigational features are interrogated substantially along the circular information tracks between a pre-selected inner and outer circumference.

In another preferred embodiment, the analysis zone includes a plurality of reaction sites and/or a plurality of capture zones or target zones arranged according to a varying angular coordinate.

The optical analysis bio-disc may also include a plurality of analysis zones positioned between the inner perimeter and the outer perimeter of the substrate, at least one of which extends according to a varying angular coordinate.

Preferably, the analysis zones of the plurality extend according to a substantially circumferential path and are concentrically arranged around the bio-disc inner perimeter.

In a variant embodiment, the disc includes multiple tiers of analysis zones, wherein each analysis zone extends according to a substantially circumferential path and each tier is arranged onto the bio-disc at a respective radial coordinate.

In a further preferred embodiment, the analysis zone includes one or more fluid chambers extending according to a varying angular coordinate, which chamber(s) has a central portion extending according to a varying angular coordinate and two lateral arm portions extending according to a radial direction.

Preferably, the chamber central portion has an angular extension θₐ being in a ratio θₐ/θ equal to or greater than 0.25 with the angle θ comprised between the chamber arm portions.

Furthermore, such embodiment may provide that the analysis zone includes at least a liquid-containing channel extending accordingly along a substantially circumferential path and the radius of curvature of the channel r_{c} and the length of the column of liquid b contained within the channel are in a ratio r_{c}/b equal to or greater than 0.5, and more preferably equal to or greater than 1.

Moreover, the optical analysis disc may include two inlet ports located at a lower radial coordinate of the bio-disc itself with respect to the analysis zone. Preferably, such ports are located each at one end of a respective lateral arm portion of the fluid chamber.

In a further preferred embodiment, the at least one fluid chamber is a fluid channel extending according to a varying angular coordinate.

In such embodiment, the disc may include multiple tiers of analysis fluid channels, eventually comprising different assays, blood types, concentrations of cultured cells and the like. A set of fluid channels can also be arranged at substantially the same radial coordinate. Furthermore, the fluid channels can have the same or different sizes.

The disc may be either a reflective-type or transmissive-type optical bio-disc. As in previous embodiments, preferably rotation of the bio-disc distributes investigational features in a substantially consistent and/or even distribution along the analysis zone.

According to another preferred embodiment, the optical analysis bio-disc may include a substrate having an inner perimeter and an outer perimeter; and an analysis zone including investigational features and positioned between the inner perimeter and the outer perimeter of the substrate. The analysis zone includes at least a liquid-containing channel having at least a portion which extends along a substantially circumferential path. The radius of curvature of the channel circumferential portion r, and the length of the column of liquid b contained within the channel are preferably in a ratio r_{c}/b equal to or greater than 0.5. More Preferably, the ratio r_{c}/b is equal to or greater than 1. Also in this embodiment, the disc can be either a reflective-type or a transmissive-type optical bio-disc.

The invention is also directed to an optical analysis bio-disc system for use with an optical analysis bio-disc as defined so far, which system includes interrogation devices of the investigational features adapted to interrogate the latter according to a varying angular coordinate.

Such interrogation devices may be such that when an incident beam of electromagnetic energy tracks along disc information tracks, any investigational features within the analysis zone are thereby interrogated circumferentially.

Preferably, the interrogation devices are adapted to,, interrogate the investigational features according to a varying angular coordinate at a substantially fixed radial coordinate or, alternatively, according to a varying angular and radial coordinate.

More preferably, the interrogation devices are employed to interrogate the investigational features according to a spiral or a substantially circumferential path.

According to a further preferred embodiment, the interrogation devices are utilized to interrogate investigational features at a plurality of reaction sites or capture or target zones arranged according to a varying angular coordinate.

The present invention is also directed to a method for the interrogation of investigational features within an optical analysis bio-disc as defined so far. This method provides interrogation of the investigational features according to a varying angular coordinate, and preferably according to a spiral or a substantially circumferential path.

Such interrogation step may also be such that when an incident beam of electromagnetic energy tracks along disc information tracks, any investigational features within the analysis zone are thereby interrogated circumferentially.

Preferably, the interrogation step provides interrogation of the investigational features according to a varying angular coordinate at a substantially fixed radial coordinate or, alternatively, according to a varying angular and radial coordinate.

According to a further preferred embodiment, the interrogation step provides interrogation of investigational features at a plurality of similar or different, reaction sites, capture zones, or target zones arranged according to a varying angular coordinate.

This invention or different aspects thereof may be readily implemented in, adapted to, or employed in combination with the discs, assays, and systems disclosed in the following commonly assigned and co-pending patent applications:

U.S. patent application Ser. No. 09/378,878 entitled “Methods and Apparatus for Analyzing Operational and Non-operational Data Acquired from Optical Discs” filed Aug. 23, 1999; U.S. Provisional Patent Application Ser. No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Biodiscs with Reflective Layers” filed Nov. 15, 2001; U.S. patent application Ser. No. 09/988,728 entitled “Methods and Apparatus for, Detecting and Quantifying Lymphocytes with Optical Biodiscs” filed Nov. 20, 2001; U.S. patent application Ser. No. 09/988,850 entitled “Methods and Apparatus for Blood Typing with Optical Bio-discs” filed Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No.10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory and Improved Optical Bio-Disc Including Same” filed Dec. 14, 2001; U.S. patent application Ser. No. 10/035,836 entitled “Surface Assembly for Immobilizing DNA Capture Probes and Bead-Based Assay Including Optical Bio-Discs and Methods Relating Thereto” filed Dec. 21, 2001; U.S. patent application Ser. No. 10/038,297 entitled “Dual Bead Assays Including Covalent Linkages for Improved Specificity and Related Optical Analysis Discs” filed Jan. 4, 2002; U.S. patent application Ser. No. 10/043,688 entitled “Optical Disc Analysis System Including Related Methods for Biological and Medical Imaging” filed Jan. 10, 2002; U.S. Provisional Application Ser. No. 60/348,767 entitled “Optical Disc Analysis System Including Related Signal Processing Methods and Software” filed Jan. 14, 2002 U.S. patent application Ser. No. 10/086,941 entitled “Methods for DNA Conjugation Onto Solid Phase Including Related Optical Biodiscs and Disc Drive Systems” filed Feb. 26, 2002; U.S. patent application Ser. No. 10/087,549 entitled “Methods for Decreasing Non-Specific Binding of Beads in Dual Bead Assays Including Related Optical Biodiscs and Disc Drive Systems” filed Feb. 28, 2002; U.S. patent application Ser. No. 10/099,256 entitled “Dual Bead Assays Using Cleavable Spacers and/or Ligation to Improve Specificity and Sensitivity Including Related Methods and Apparatus” filed Mar. 14, 2002; U.S. patent application Ser. No. 10/099,266 entitled “Use of Restriction Enzymes and Other Chemical Methods to Decrease Non-Specific Binding in Dual Bead Assays and Related Bio-Discs, Methods, and System Apparatus for Detecting Medical Targets” also filed Mar. 14, 2002; U.S. patent application Ser. No. 10/121,281 entitled “Multi-Parameter Assays Including Analysis Discs and Methods Relating Thereto” filed Apr. 11, 2002; U.S. patent application Ser. No. 10/150,575 entitled “Variable Sampling Control for Rendering Pixelization of Analysis Results in a Bio-Disc Assembly and Apparatus Relating Thereto” filed May 16, 2002; U.S. patent application Ser. No. 10/150,702 entitled “Surface Assembly For Immobilizing DNA Capture Probes in Genetic Assays Using Enzymatic Reactions to Generate Signals in Optical Bio-Discs and Methods Relating Thereto” filed May 17, 2002; U.S. patent application Ser. No.10/194,418 entitled “Optical Disc System and Related Detecting and Decoding Methods for Analysis of Microscopic Structures” filed Jul. 12, 2002; U.S. patent application Ser. No. 10/194,396 entitled “Multi-Purpose Optical Analysis Disc for Conducting Assays and Various Reporting Agents for Use Therewith” also filed Jul. 12, 2002; U.S. patent application Ser. No. 10/199,973 entitled “Transmissive Optical Disc Assemblies for Performing Physical Measurements and Methods Relating Thereto” filed Jul. 19, 2002; U.S. patent application Ser. No. 10/201,591 entitled “Optical Analysis Disc and Related Drive Assembly for Performing Interactive Centrifugation” filed Jul. 22, 2002; U.S. patent application Ser. No. 10/205,011 entitled “Method and Apparatus for Bonded Fluidic Circuit for Optical Bio-Disc” filed Jul. 24, 2002; U.S. patent application Ser. No. 10/205,005 entitled “Magnetic Assisted Detection of Magnetic Beads Using Optical Disc Drives” also filed Jul. 24, 2002; U.S. patent application Ser. No. 10/230,959 entitled “Methods for Qualitative and Quantitative Analysis of Cells and Related Optical Bio-Disc Systems” filed Aug. 29, 2002; U.S. patent application Ser. No. 10/233,322 entitled “Capture Layer Assemblies for Cellular Assays Including Related Optical Analysis Discs and Methods” filed Aug. 30, 2002; U.S. patent application Ser. No. 10/236,857 entitled “Nuclear Morphology Based Identification and Quantification of White Blood Cell Types Using Optical Bio-Disc Systems” filed Sep. 6, 2002; U.S. patent application Ser. No. 10/241,512 entitled “Methods for Differential Cell Counts Including Related Apparatus and Software for Performing Same” filed Sep. 11, 2002; U.S. patent application Ser. No. 10/279,677 entitled “Segmented Area Detector for Biodrive and Methods Relating Thereto” filed Oct. 24, 2002; U.S. patent application Ser. No. 10/293,214 entitled “Optical Bio-Discs and Fluidic Circuits for Analysis of Cells and Methods Relating Thereto” filed on Nov. 13, 2002; U.S. patent application Ser. No. 10/298,263 entitled “Methods and Apparatus for Blood Typing with Optical Bio-Discs” filed on Nov. 15, 2002; and U.S. patent application Ser. No. 10/307,263 entitled “Magneto-Optical Bio-Discs and Systems Including Related Methods” filed Nov. 27, 2002. All of these applications are herein incorporated by reference in their entireties. They thus provide background and related disclosure as support hereof as if fully repeated herein.

The above described methods and apparatus according to the present invention as disclosed herein can have one or more advantages which include, but are not limited to, simple and quick on-disc processing without the necessity of an experienced technician to run the test, small sample volumes, use of inexpensive materials, and use of known optical disc formats and drive manufacturing. These and other features and advantages will be better understood by reference to the following detailed description when taken in conjunction with the accompanying drawing figures and technical examples.

### BRIEF DESCRIPTION OF THE DRAWINGS

Further objects of the present invention together with additional features contributing thereto and advantages accruing therefrom will be apparent from the following description of the preferred embodiments of the invention which are shown in the accompanying drawing figures with like reference numerals indicating like components throughout, wherein:

FIG. 1 is a pictorial representation of a bio-disc system;

FIG. 2 is an exploded perspective view of a reflective bio-disc;

FIG. 3 is a top plan view of the disc shown in FIG. 2;

FIG. 4 is a perspective view of the disc illustrated in FIG. 2 with cut-away sections showing the different layers of the disc;

FIG. 5 is an exploded perspective view of a transmissive bio-disc;

FIG. 6 is a perspective view representing the disc shown in FIG. 5 with a cut-away section illustrating the functional aspects of a semi-reflective layer of the disc;

FIG. 7 is a graphical representation showing the relationship between thickness and transmission of a thin gold film;

FIG. 8 is a top plan view of the disc shown in FIG. 5;

FIG. 9 is a perspective view of the disc illustrated in FIG. 5 with cut-away sections showing the different layers of the disc including the type of semi-reflective layer shown in FIG. 6;

FIG. 10 is a perspective and block diagram representation illustrating the system of FIG. 1 in more detail;

FIG. 11 is a partial cross sectional view taken perpendicular to a radius of the reflective optical bio-disc illustrated in FIGS. 2, 3, and 4 showing a flow channel formed therein;

FIG. 12 is a partial cross sectional view taken perpendicular to a radius of the transmissive optical bio-disc illustrated in FIGS. 5, 8, and 9 showing a flow channel formed therein and a top detector;

FIG. 13 is a partial longitudinal cross sectional view of the reflective optical bio-disc shown in FIGS. 2, 3, and 4 illustrating a wobble groove formed therein;

FIG. 14 is a partial longitudinal cross sectional view of the transmissive optical bio-disc illustrated in FIGS. 5, 8, and 9 showing a wobble groove formed therein and a top detector;

FIG. 15 is a view similar to FIG. 11 showing the entire thickness of the reflective disc and the initial refractive property thereof;

FIG. 16 is a view similar to FIG. 12 showing the entire thickness of the transmissive disc and the initial refractive property thereof;

FIG. 17 is a pictorial graphical representation of the transformation of a sampled analog signal to a corresponding digital signal that is stored as a one-dimensional array;

FIG. 18 is a perspective view of an optical disc with an enlarged detailed view of an indicated section showing a captured white blood cell positioned relative to the tracks of the bio-disc yielding a signal-containing beam after interacting with an incident beam;

FIG. 19A is a graphical representation of a white blood cell positioned relative to the tracks of an optical bio-disc;

FIG. 19B is a series of signature traces derived from the white blood cell of FIG. 19A;

FIG. 20 is a graphical representation illustrating the relationship between FIGS. 20A, 20B, 20C, and 20D;

FIGS. 20A, 20B, 20C, and 20D, when taken together, form a pictorial graphical representation of transformation of the signature traces from FIG. 19B into digital signals that are stored as one-dimensional arrays and combined into a two-dimensional array for data input;

FIG. 21 is a logic flow chart depicting the principal steps for data evaluation according to processing methods and computational algorithms related to the present invention;

FIG. 22 is an exploded perspective view of an embodiment of bio-disc according to the present invention;

FIG. 23 is a top plan view of the disc of FIG. 22;

FIG. 24 is a top plan view of another embodiment of bio-disc according to the present invention;

FIG. 25 is a top plan view of a further embodiment of bio-disc according to the present invention;

FIG. 26 is a schematic representation in top plan view of a portion of the bio-disc of FIG. 25 showing an analyte particle motion;

FIGS. 27A to 27C are each a schematic representation in top plan view of a portion of a bio-disc with indication of construction parameters thereof, wherein FIGS. 27A and 27C relate to the bio-disc of FIG. 22, and FIG. 27B relates to the bio-disc of FIG. 2;

FIGS. 28A is an exploded perspective view of a reflective bio-disc incorporating the equi-radial channels of the present invention;

FIG. 28B is a top plan view of the disc shown in FIG. 28A;

FIG. 28C is a perspective view of the disc illustrated in FIG. 28A with cut-away sections showing the different layers of the e-radial reflective disc;

FIGS. 29A is an exploded perspective view of a transmissive bio-disc utilizing the e-radial channels of the present invention;

FIG. 29B is a top plan view of the disc shown in FIG. 29A;

FIG. 29C is a perspective view of the disc illustrated in FIG. 29A with cut-away sections showing the different layers of this embodiment of the e-rad transmissive bio-disc;

FIGS. 30 and 31 are each a top plan view of a respective additional embodiment of the bio-disc of the present invention each shown in a bio-safe jewel case;

FIGS. 32 to 36 are each top plan view of an adhesive member or channel layer of respective embodiments of the bio-disc of the present invention; and

FIGS. 37 to 39 are each top plan views of respective still further embodiments of the bio-disc according to the present invention showing the e-rad channel with capture zones or target zones respectively.

### DETAILED DESCRIPTION OF THE INVENTION

The present invention is directed to disc drive systems, optical bio-discs, image processing techniques, analysis methods, and related software. Each of these aspects of the present invention is discussed below in further detail.

Drive System and Related Discs

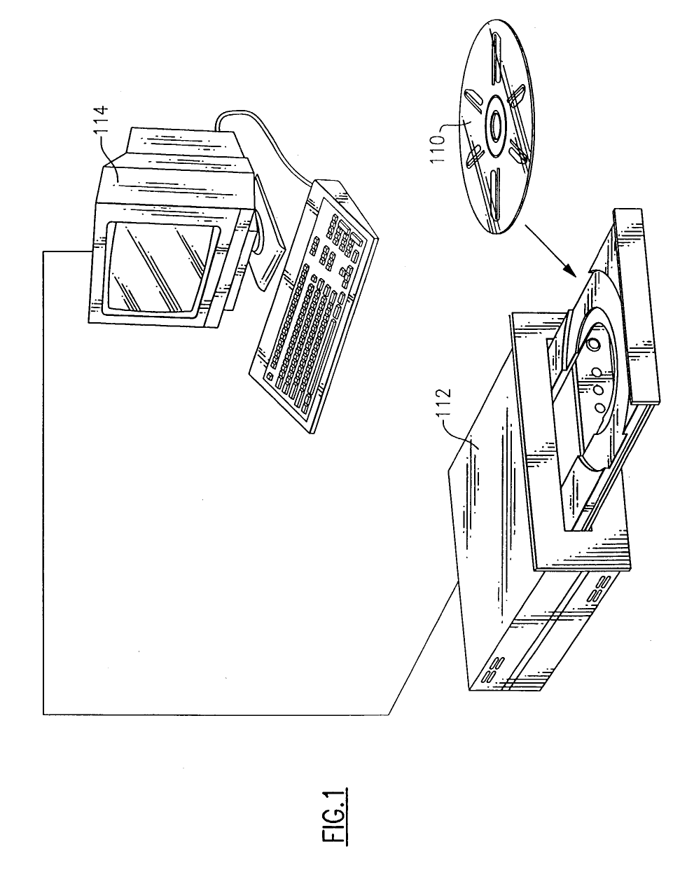

FIG. 1 is a perspective view of an optical bio-disc 110 for conducting biochemical analyses, and in particular cell counts and differential cell counts. The present optical bio-disc 110 is shown in conjunction with an optical disc drive 112 and a display monitor 114. Further details relating to this type of disc drive and disc analysis system are disclosed in commonly assigned and co-pending U.S. patent application Ser. No. 10/008,156 entitled “Disc Drive System and Methods for Use with Bio-discs” filed Nov. 9, 2001 and U.S. patent application Ser. No. 10/043,688 entitled “Optical Disc Analysis System Including Related Methods For Biological and Medical Imaging” filed Jan. 10, 2002, both of which are herein incorporated by reference.

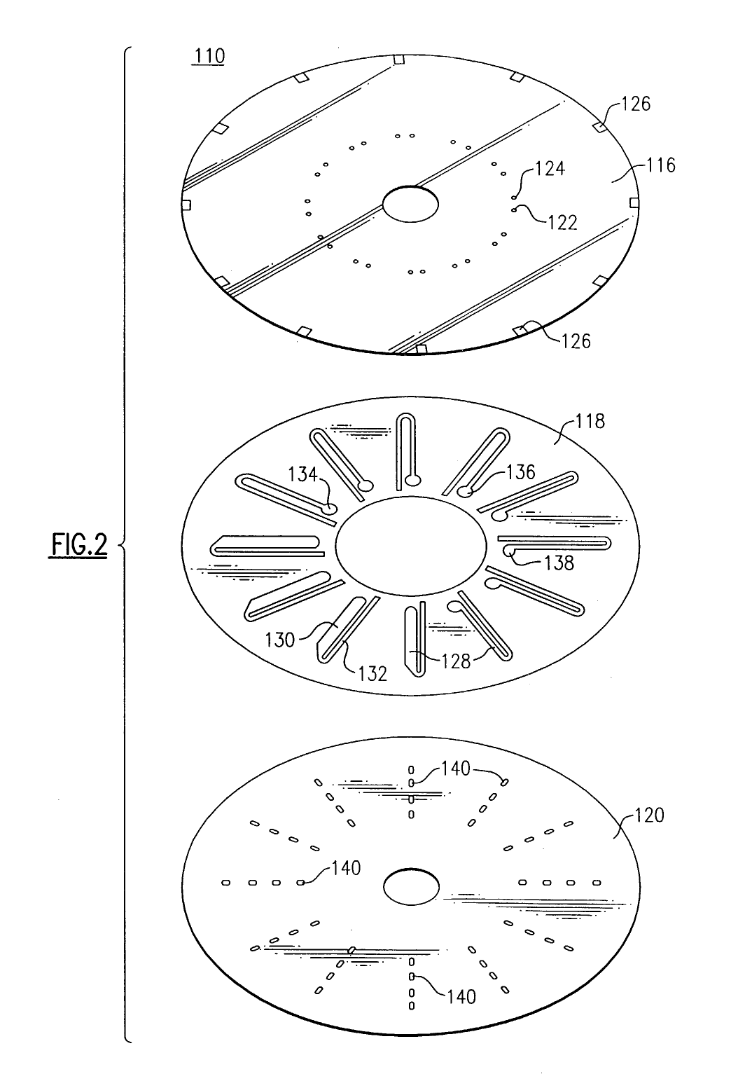

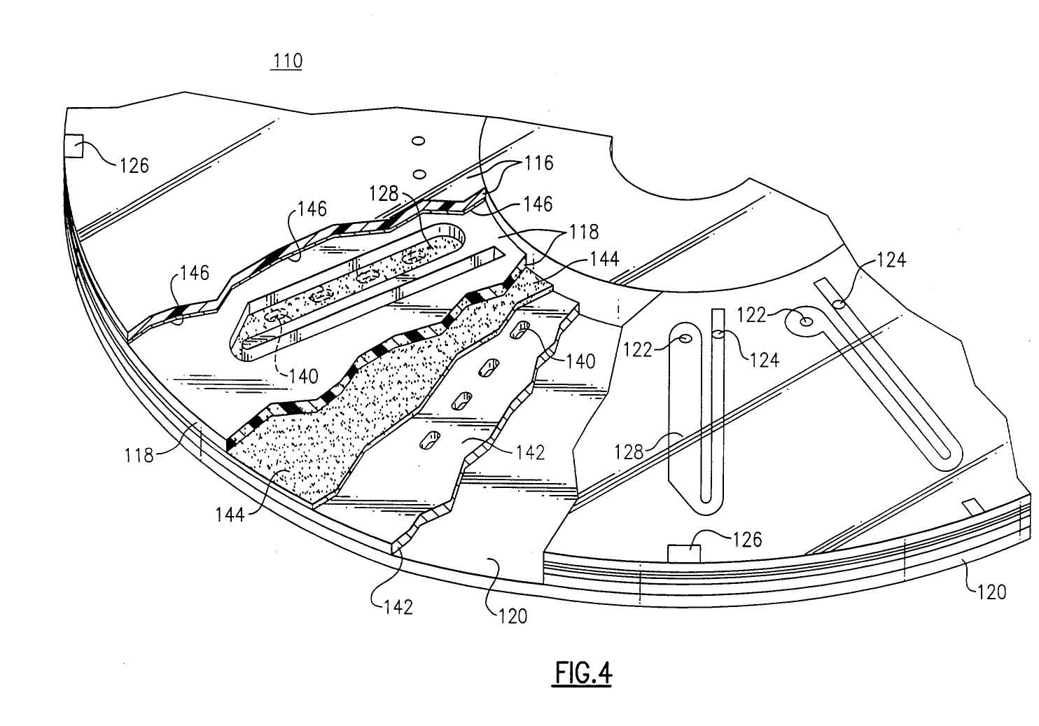

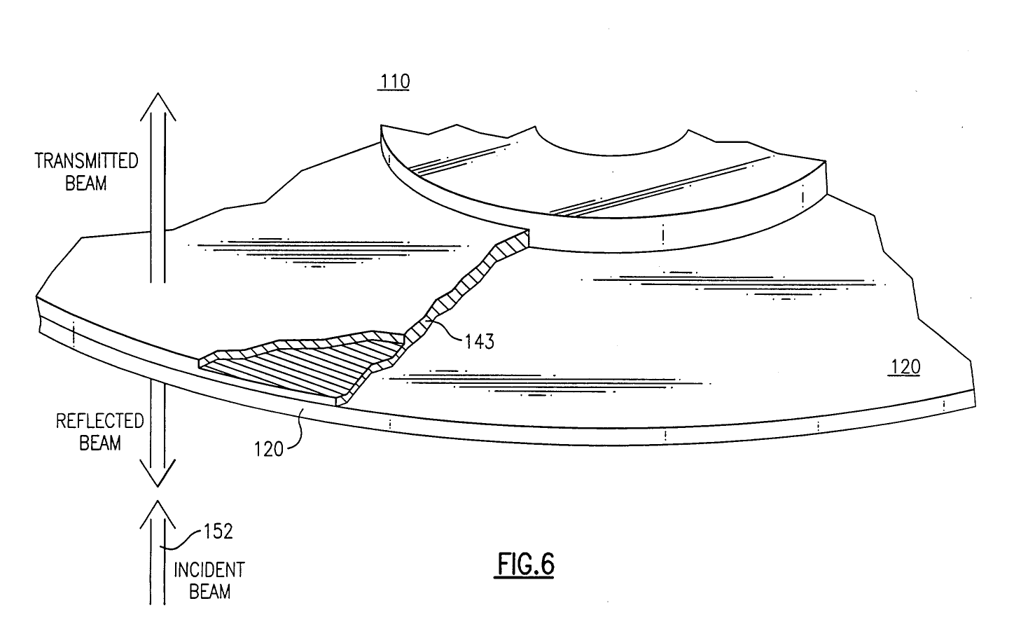

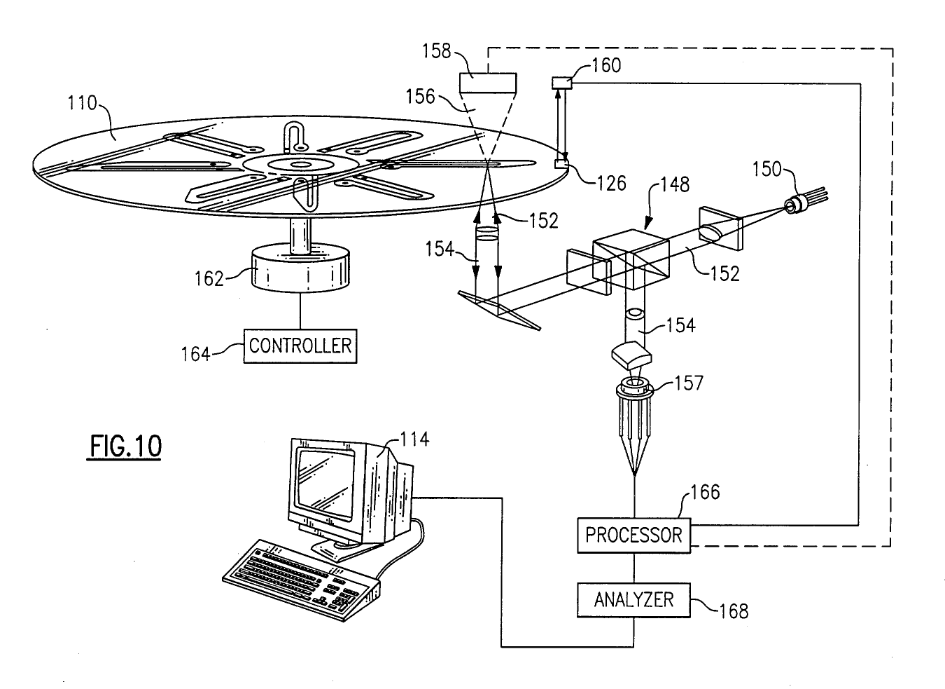

FIG. 2 is an exploded perspective view of the principal structural elements of one embodiment of the optical bio-disc 110. FIG. 2 is an example of a reflective zone optical bio-disc 110 (hereinafter “reflective disc”) that may be used in the present invention. The principal structural elements include a cap portion 116, an adhesive member or channel layer 118, and a substrate 120. The cap portion 116 includes one or more inlet ports 122 and one or more vent ports 124. The cap portion 116 may be formed from polycarbonate and is preferably coated with a reflective surface 146 (shown in FIG. 4) on the bottom thereof as viewed from the perspective of FIG. 2. In the preferred embodiment, trigger marks or markings 126 are included on the surface of a reflective layer 142 (shown FIG. 4). Trigger markings 126 may include a clear window in all three layers of the bio-disc, an opaque area, or a reflective or semi-reflective area encoded with information that sends data to a processor 166, as shown FIG. 10, that in turn interacts with the operative functions of an interrogation or incident beam 152, as shown in FIGS. 6 and 10.

The second element shown in FIG. 2 is an adhesive member or channel layer 118 having fluidic circuits 128 or U-channels formed therein. The fluidic circuits 128 are formed by stamping or cutting the membrane to remove plastic film and form the shapes as indicated. Each of the fluidic circuits 128 includes a flow channel 130 and a return channel 132. Some of the fluidic circuits 128 illustrated in FIG. 2 include a mixing chamber 134. Two different types of mixing chambers 134 are illustrated. The first is a symmetric mixing chamber 136 that is symmetrically formed relative to the flow channel 130. The second is an off-set mixing chamber 138. The off-set mixing chamber 138 is formed to one side of the flow channel 130 as indicated.

The third element illustrated in FIG. 2 is a substrate 120 including target or capture zones 140. The substrate 120 is preferably made of polycarbonate and has the aforementioned reflective layer 142 deposited on the top thereof (shown in FIG. 4). The target zones 140 are formed by removing the reflective layer 142 in the indicated shape or alternatively in any desired shape. Alternatively, the target zone 140 may be formed by a masking technique that includes masking the target zone 140 area before applying the reflective layer 142. The reflective layer 142 may be formed from a metal such as aluminum or gold.

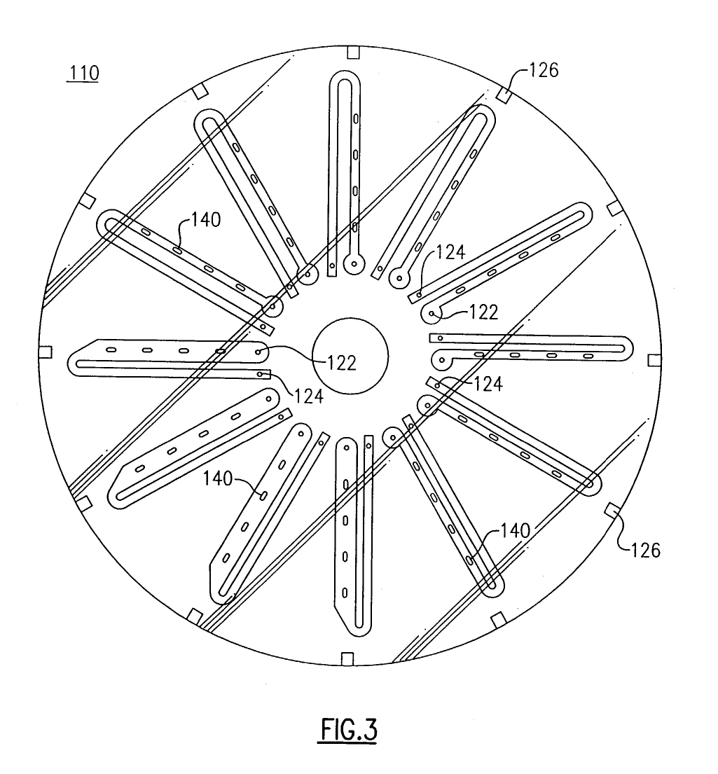

FIG. 3 is a top plan view of the optical bio-disc 110 illustrated in FIG. 2 with the reflective layer 146 on the cap portion 116 shown as transparent to reveal the fluidic circuits 128, the target zones 140, and trigger markings 126 situated within the disc.

FIG. 4 is an enlarged perspective view of the reflective zone type optical bio-disc 110 according to one embodiment that may be used in the present invention. This view includes a portion of the various layers thereof, cut away to illustrate a partial sectional view of each principal layer, substrate, coating, or membrane. FIG. 4 shows the substrate 120 that is coated with the reflective layer 142. An active layer 144 is applied over the reflective layer 142. In the preferred embodiment, the active layer 144 may be formed from polystyrene. Alternatively, polycarbonate, gold, activated glass, modified glass, or modified polystyrene, for example, polystyrene-co-maleic anhydride, may be used. In addition, hydrogels can be used. Alternatively, as illustrated in this embodiment, the plastic adhesive member 118 is applied over the active layer 144. The exposed section of the plastic adhesive member 118 illustrates the cut out or stamped U-shaped form that creates the fluidic circuits 128. The final principal structural layer in this reflective zone embodiment of the present bio-disc is the cap portion 116. The cap portion 116 includes the reflective surface 146 on the bottom thereof. The reflective surface 146 may be made from a metal such as aluminum or gold.

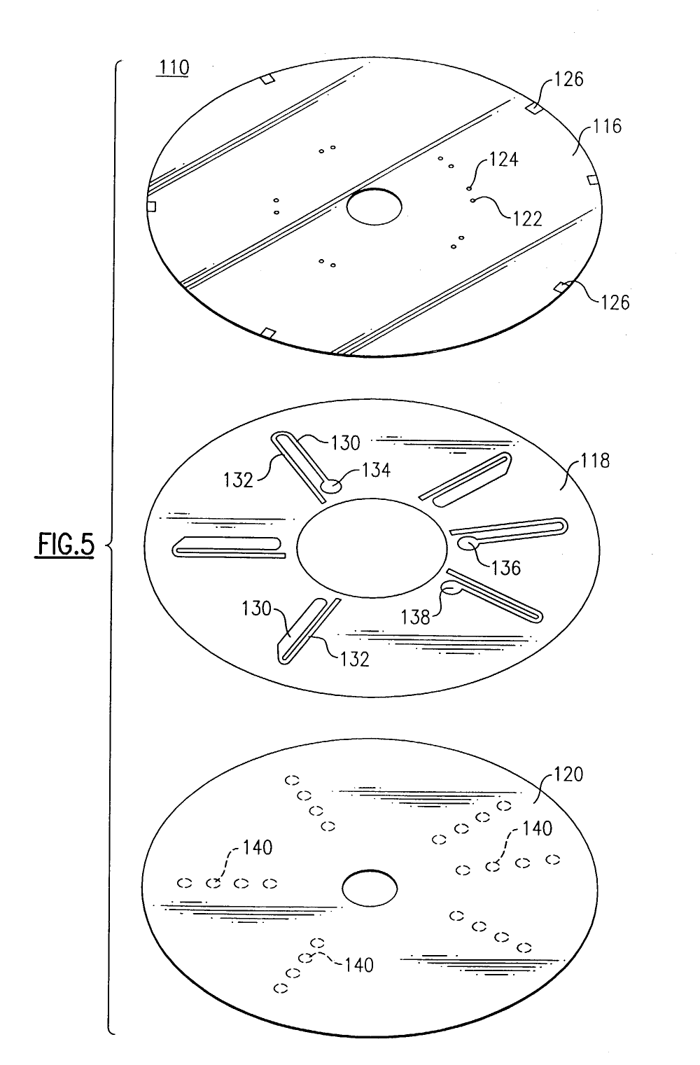

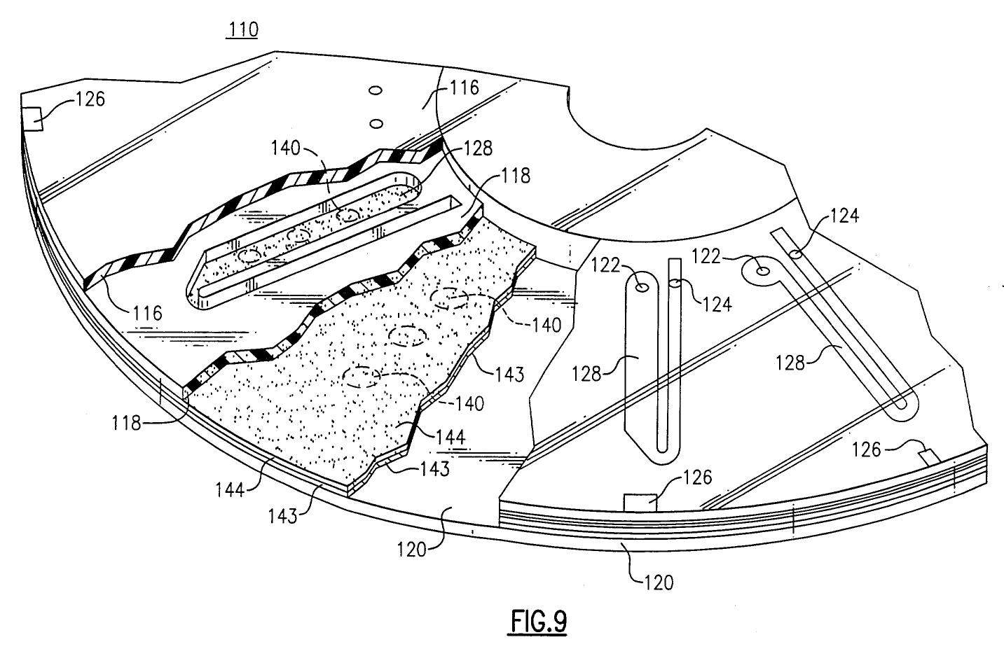

Referring now to FIG. 5, there is shown an exploded perspective view of the principal structural elements of a transmissive type of optical bio-disc 110. The principal structural elements of the transmissive type of optical bio-disc 110 similarly include the cap portion 116, the adhesive or channel member 118, and the substrate 120 layer. The cap portion 116 includes one or more inlet ports 122 and one or more vent ports 124. The cap portion 116 may be formed from a polycarbonate layer. Optional trigger markings 126 may be included on the surface of a thin semi-reflective layer 143, as best illustrated in FIGS. 6 and 9. Trigger markings 126 may include a clear window in all three layers of the bio-disc, an opaque area, or a reflective or semi-reflective area encoded with information that sends data to a processor 166, FIG. 10, which in turn interacts with the operative functions of an interrogation beam 152, FIGS. 6 and 10.

The second element shown in FIG. 5 is the adhesive member or channel layer 118 having fluidic circuits 128 or U-channels formed therein. The fluidic circuits 128 are formed by stamping or cutting the membrane to remove plastic film and form the shapes as indicated. Each of the fluidic circuits 128 includes the flow channel 130 and the return channel 132. Some of the fluidic circuits 128 illustrated in FIG. 5 include a mixing chamber 134. Two different types of mixing chambers 134 are illustrated. The first is a symmetric mixing chamber 136 that is symmetrically formed relative to the flow channel 130. The second is an off-set mixing chamber 138. The off-set mixing chamber 138 is formed to one side of the flow channel 130 as indicated.

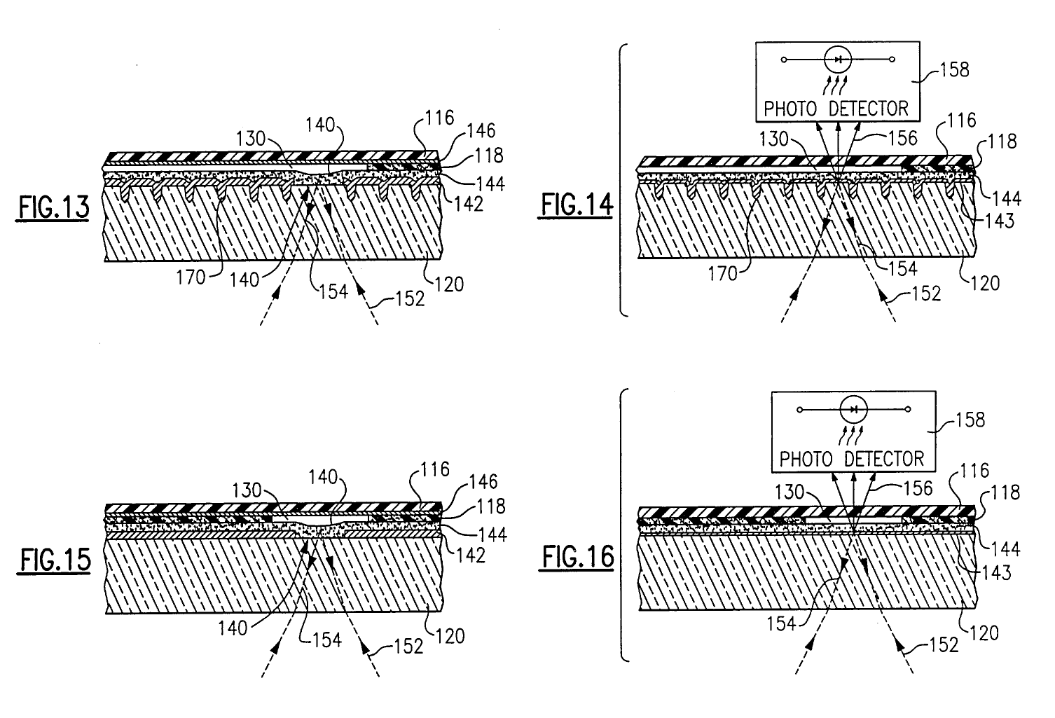

The third element illustrated in FIG. 5 is the substrate 120 which may include target or capture zones 140. The substrate 120 is preferably made of polycarbonate and has the aforementioned thin semi-reflective layer 143 deposited on the top thereof, FIG. 6. The semi-reflective layer 143 associated with the substrate 120 of the disc 110 illustrated in FIGS. 5 and 6 is significantly thinner than the reflective layer 142 on the substrate 120 of the reflective disc 110 illustrated in FIGS. 2, 3 and 4. The thinner semi-reflective layer 143 allows for some transmission of the interrogation beam 152 through the structural layers of the transmissive disc as shown in FIGS. 6 and 12. The thin semi-reflective layer 143 may be formed from a metal such as aluminum or gold.

FIG. 6 is an enlarged perspective view of the substrate 120 and semi-reflective layer 143 of the transmissive embodiment of the optical bio-disc 110 illustrated in FIG. 5. The thin semi-reflective layer 143 may be made from a metal such as aluminum or gold. In the preferred embodiment, the thin semi-reflective layer 143 of the transmissive disc illustrated in FIGS. 5 and 6 is approximately 100-300 Å thick and does not exceed 400 Å. This thinner semi-reflective layer 143 allows a portion of the incident or interrogation beam 152 to penetrate and pass through the semi-reflective layer 143 to be detected by a top detector 158, FIGS. 10 and 12, while some of the light is reflected or returned back along the incident path. As indicated below, Table 1 presents the reflective and transmissive characteristics of a gold film relative to the thickness of the film. The gold film layer is fully reflective at a thickness greater than 800 Å. While the threshold density for transmission of light through the gold film is approximately 400 Å.

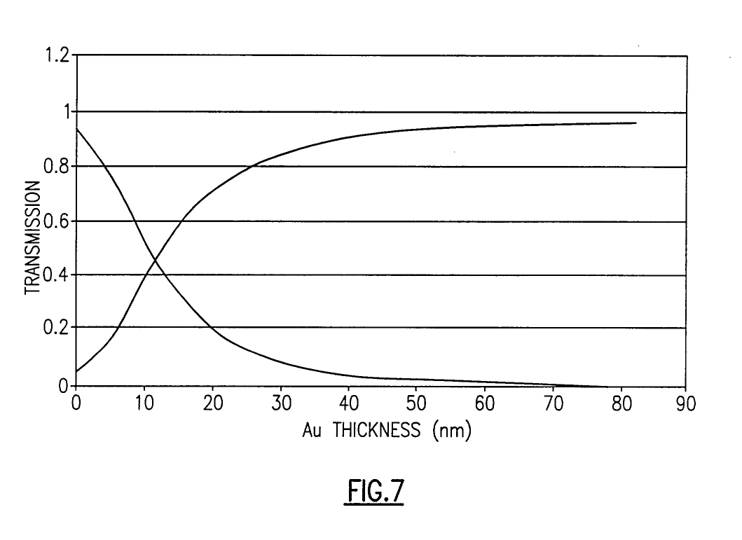

In addition to Table 1, FIG. 7 provides a graphical representation of the inverse relationship of the reflective and transmissive nature of the thin semi-reflective layer 143 based upon the thickness of the gold. Reflective and transmissive values used in the graph illustrated in FIG. 7 are absolute values.

TABLE 1
Au film Reflection and Transmission (Absolute Values)

| Thickness (Angstroms) | Thickness (nm) | Reflectance | Transmittance |
|---|---|---|---|
| 0 | 0 | 0.0505 | 0.9495 |
| 50 | 5 | 0.1683 | 0.7709 |
| 100 | 10 | 0.3981 | 0.5169 |
| 150 | 15 | 0.5873 | 0.3264 |
| 200 | 20 | 0.7142 | 0.2057 |
| 250 | 25 | 0.7959 | 0.1314 |
| 300 | 30 | 0.8488 | 0.0851 |
| 350 | 35 | 0.8836 | 0.0557 |
| 400 | 40 | 0.9067 | 0.0368 |
| 450 | 45 | 0.9222 | 0.0244 |
| 500 | 50 | 0.9328 | 0.0163 |
| 550 | 55 | 0.9399 | 0.0109 |
| 600 | 60 | 0.9448 | 0.0073 |
| 650 | 65 | 0.9482 | 0.0049 |
| 700 | 70 | 0.9505 | 0.0033 |
| 750 | 75 | 0.9520 | 0.0022 |
| 800 | 80 | 0.9531 | 0.0015 |

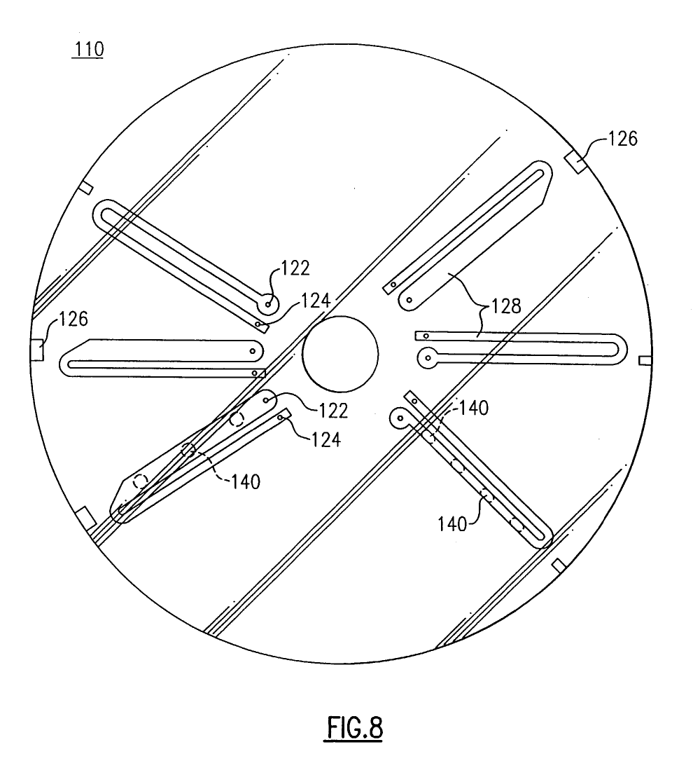

With reference next to FIG. 8, there is shown a top plan view of the transmissive type optical bio-disc 110 illustrated in FIGS. 5 and 6 with the transparent cap portion 116 revealing the fluidic channels, the trigger markings 126, and the target zones 140 as situated within the disc.

FIG. 9 is an enlarged perspective view of the optical bio-disc 110 according to the transmissive disc embodiment. The disc 110 is illustrated with a portion of the various layers thereof cut away to show a partial sectional view of each principal layer, substrate, coating, or membrane. FIG. 9 illustrates a transmissive disc format with the clear cap portion 116, the thin semi-reflective layer 143 on the substrate 120, and trigger markings 126. In this embodiment, trigger markings 126 include opaque material placed on the top portion of the cap. Alternatively the trigger marking 126 may be formed by clear, non-reflective windows etched on the thin reflective layer 143 of the disc, or any mark that absorbs or does not reflect the signal coming from a trigger detector 160, FIG. 10. FIG. 9 also shows the target zones 140 formed by marking the designated area in the indicated shape or alternatively in any desired shape. Markings to indicate target zone 140 may be made on the thin semi-reflective layer 143 on the substrate 120 or on the bottom portion of the substrate 120 (under the disc). Alternatively, the target zones 140 may be formed by a masking technique that includes masking the entire thin semi-reflective layer 143 except the target zones 140. In this embodiment, target zones 140 may be created by silk screening ink onto the thin semi-reflective layer 143. In the transmissive disc format illustrated in FIGS. 5, 8, and 9, the target zones 140 may alternatively be defined by address information encoded on the disc. In this embodiment, target zones 140 do not include a physically discernable edge boundary.

With continuing reference to FIG. 9, an active layer 144 is illustrated as applied over the thin semi-reflective layer 143. In the preferred embodiment, the active layer 144 is a 10 to 200 μm thick layer of 2% polystyrene. Alternatively, polycarbonate, gold, activated glass, modified glass, or modified polystyrene, for example, polystyrene-co-maleic anhydride, may be used. In addition, hydrogels can be used. As illustrated in this embodiment, the plastic adhesive member 118 is applied over the active layer 144. The exposed section of the plastic adhesive member 118 illustrates the cut out or stamped U-shaped form that creates the fluidic circuits 128.

The final principal structural layer in this transmissive embodiment of the present bio-disc 110 is the clear, non-reflective cap portion 116 that includes inlet ports 122 and vent ports 124.

Referring now to FIG. 10, there is a representation in perspective and block diagram illustrating optical components 148, a light source 150 that produces the incident or interrogation beam 152, a return beam 154, and a transmitted beam 156. In the case of the reflective bio-disc illustrated in FIG. 4, the return beam 154 is reflected from the reflective surface 146 of the cap portion 116 of the optical bio-disc 110. In this reflective embodiment of the present optical bio-disc 110, the return beam 154 is detected and analyzed for the presence of signal elements by a bottom detector 157. In the transmissive bio-disc format, on the other hand, the transmitted beam 156 is detected, by the aforementioned top detector 158, and is also analyzed for the presence of signal elements. In the transmissive embodiment, a photo detector may be used as top detector 158.

FIG. 10 also shows a hardware trigger mechanism that includes the trigger markings 126 on the disc and the aforementioned trigger detector 160. The hardware triggering mechanism is used in both reflective bio-discs (FIG. 4) and transmissive bio-discs (FIG. 9). The triggering mechanism allows the processor 166 to collect data only when the interrogation beam 152 is on a respective target zone 140, e.g. at a predetermined reaction site. Furthermore, in the transmissive bio-disc system, a software trigger may also be used. The software trigger uses the bottom detector to signal the processor 166 to collect data as soon as the interrogation beam 152 hits the edge of a respective target zone 140. FIG. 10 further illustrates a drive motor 162 and a controller 164 for controlling the rotation of the optical bio-disc 110. FIG. 10 also shows the processor 166 and analyzer 168 implemented in the alternative for processing the return beam 154 and transmitted beam 156 associated with the transmissive optical bio-disc.

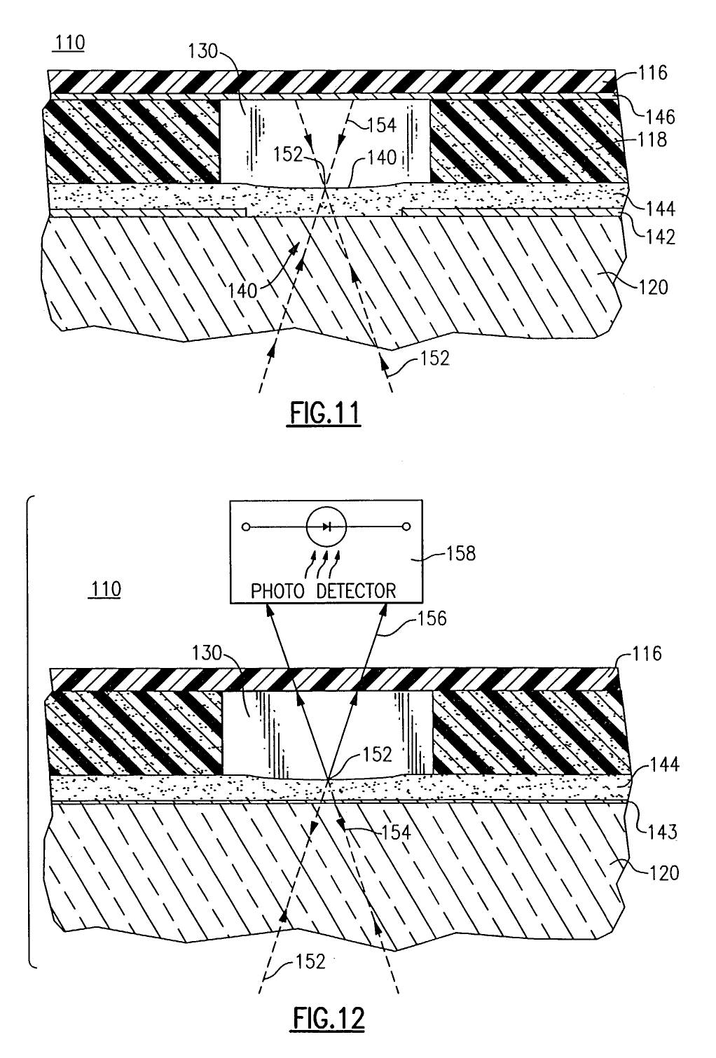

As shown in FIG. 11, there is presented a partial cross sectional view of the reflective disc embodiment of the optical bio-disc 110. FIG. 11 illustrates the substrate 120 and the reflective layer 142. As indicated above, the reflective layer 142 may be made from a material such as aluminum, gold or other suitable reflective material. In this embodiment, the top surface of the substrate 120 is smooth. FIG. 11 also shows the active layer 144 applied over the reflective layer 142. As also shown in FIG. 11, the target zone 140 is formed by removing an area or portion of the reflective layer 142 at a desired location or, alternatively, by masking the desired area prior to applying the reflective layer 142. As further illustrated in FIG. 11, the plastic adhesive member 118 is applied over the active layer 144. FIG. 11 also shows the cap portion 116 and the reflective surface 146 associated therewith. Thus when the cap portion 116 is applied to the plastic adhesive member 118 including the desired cutout shapes, flow channel 130 is thereby formed. As indicated by the arrowheads shown in FIG. 11, the path of the incident beam 152 is initially directed toward the substrate 120 from below the disc 110. The incident beam then focuses at a point proximate the reflective layer 142. Since this focusing takes place in the target zone 140 where a portion of the reflective layer 142 is absent, the incident continues along a path through the active layer 144 and into the flow channel 130. The incident beam 152 then continues upwardly traversing through the flow channel to eventually fall incident onto the reflective surface 146. At this point, the incident beam 152 is returned or reflected back along the incident path and thereby forms the return beam 154.

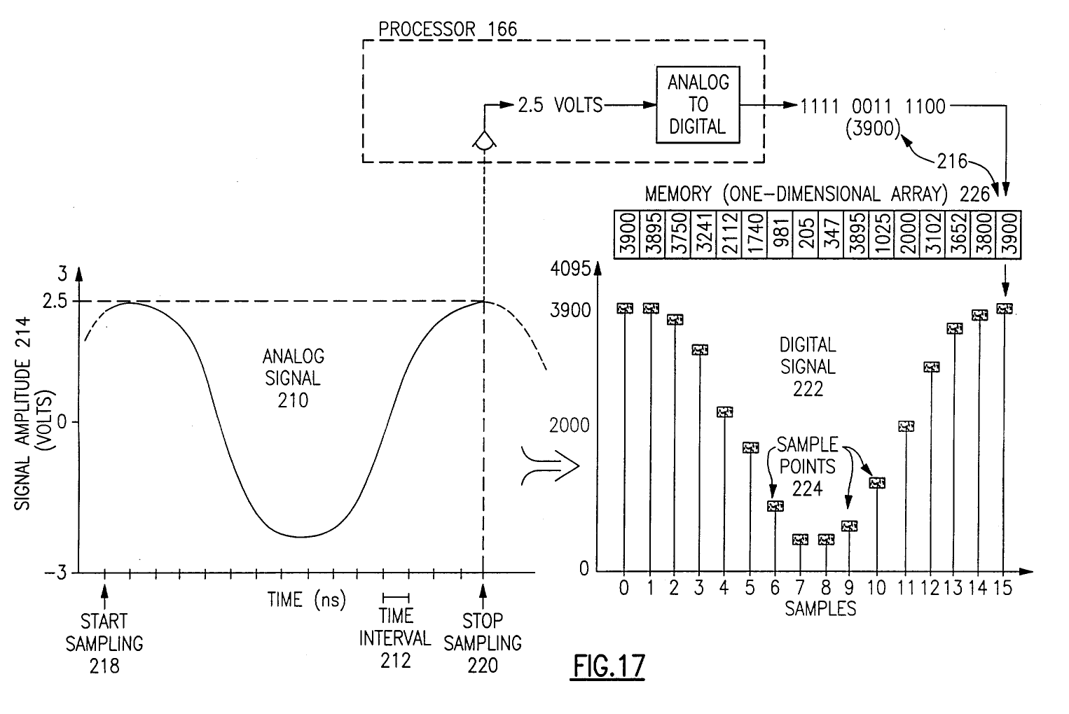

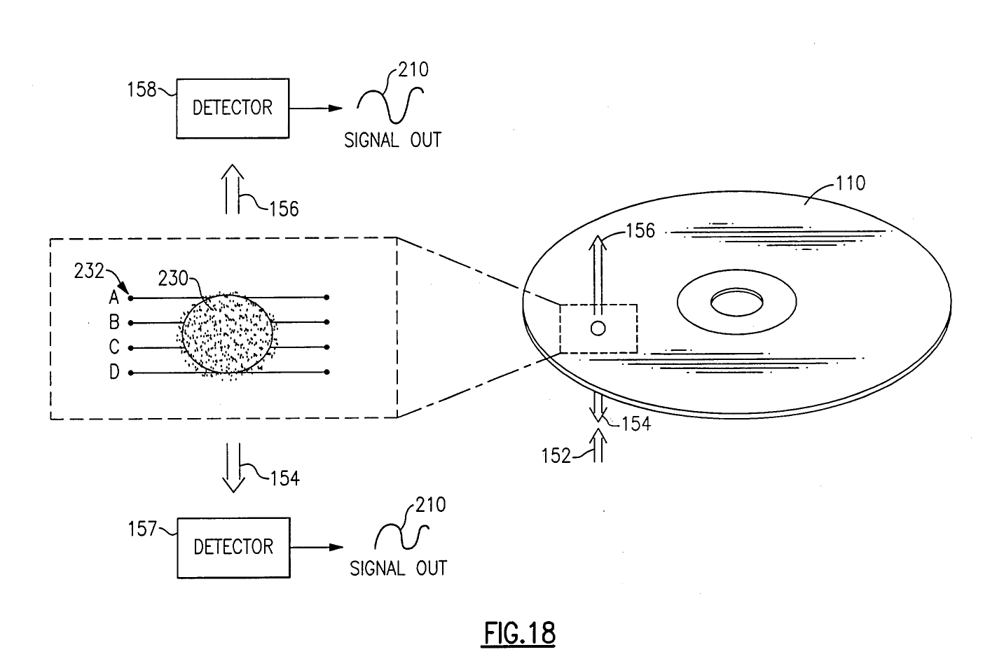

FIG. 12 is a partial cross sectional view of the transmissive embodiment of the bio-disc 110. FIG. 12 illustrates a transmissive disc format with the clear cap portion 116 and the thin semi-reflective layer 143 on the substrate 120. FIG. 12 also shows the active layer 144 applied over the thin semi-reflective layer 143. In the preferred embodiment, the transmissive disc has the thin semi-reflective layer 143 made from a metal such as aluminum or gold approximately 100-300 Angstroms thick and does not exceed 400 Angstroms. This thin semi-reflective layer 143 allows a portion of the incident or interrogation beam 152, from the light source 150, FIG. 10, to penetrate and pass upwardly through the disc to be detected by top detector 158, while some of the light is reflected back along the same path as the incident beam but in the opposite direction. In this arrangement, the return or reflected beam 154 is reflected from the semi-reflective layer 143. Thus in this manner, the return beam 154 does not enter into the flow channel 130. The reflected light or return beam 154 may be used for tracking the incident beam 152 on pre-recorded information tracks formed in or on the semi-reflective layer 143 as described in more detail in conjunction with FIGS. 13 and 14. In the disc embodiment illustrated in FIG. 12, a physically defined target zone 140 may or may not be present. Target zone 140 may be created by direct markings made on the thin semi-reflective layer 143 on the substrate 120. These marking may be formed using silk screening or any equivalent method. In the alternative embodiment where no physical indicia are employed to define a target zone (such as, for example, when encoded software addressing is utilized) the flow channel 130 in effect may be employed as a confined target area in which inspection of an investigational feature is conducted.

FIG. 13 is a cross sectional view taken across the tracks of the reflective disc embodiment of the bio-disc 110. This view is taken longitudinally along a radius and flow channel of the disc. FIG. 13 includes the substrate 120 and the reflective layer 142. In this embodiment, the substrate 120 includes a series of grooves 170. The grooves 170 are in the form of a spiral extending from near the center of the disc toward the outer edge. The grooves 170 are implemented so that the interrogation beam 152 may track along the spiral grooves 170 on the disc. This type of groove 170 is known as a “wobble groove”. A bottom portion having undulating or wavy sidewalls forms the groove 170, while a raised or elevated portion separates adjacent grooves 170 in the spiral. The reflective layer 142 applied over the grooves 170 in this embodiment is, as illustrated, conformal in nature. FIG. 13 also shows the active layer 144-applied over the reflective layer 142. As shown in FIG. 13, the target zone 140 is formed by removing an area or portion of the reflective layer 142 at a desired location or, alternatively, by masking the desired area prior to applying the reflective layer 142. As further illustrated in FIG. 13, the plastic adhesive member 118 is applied over the active layer 144. FIG. 13 also shows the cap portion 116 and the reflective surface 146 associated therewith. Thus, when the cap portion 116 is applied to the plastic adhesive member 118 including the desired cutout shapes, the flow channel 130 is thereby formed.

FIG. 14 is a cross sectional view taken across the tracks of the transmissive disc embodiment of the bio-disc 110 as described in FIG. 12, for example. This view is taken longitudinally along a radius and flow channel of the disc. FIG. 14 illustrates the substrate 120 and the thin semi-reflective layer 143. This thin semi-reflective layer 143 allows the incident or interrogation beam 152, from the light source 150, to penetrate and pass through the disc to be detected by the top detector 158, while some of the light is reflected back in the form of the return beam 154. The thickness of the thin semi-reflective layer 143 is determined by the minimum amount of reflected light required by the disc reader to maintain its tracking ability. The substrate 120 in this embodiment, like that discussed in FIG. 13, includes the series of grooves 170. The grooves 170 in this embodiment are also preferably in the form of a spiral extending from near the center of the disc toward the outer edge. The grooves 170 are implemented so that the interrogation beam 152 may track along the spiral. FIG. 14 also shows the active layer 144 applied over the thin semi-reflective layer 143. As further illustrated in FIG. 14, the plastic adhesive member or channel layer 118 is applied over the active layer 144. FIG. 14 also shows the cap portion 116 without a reflective surface 146. Thus, when the cap is applied to the plastic adhesive member 118 including the desired cutout shapes, the flow channel 130 is thereby formed and a part of the incident beam 152 is allowed to pass therethrough substantially unreflected.

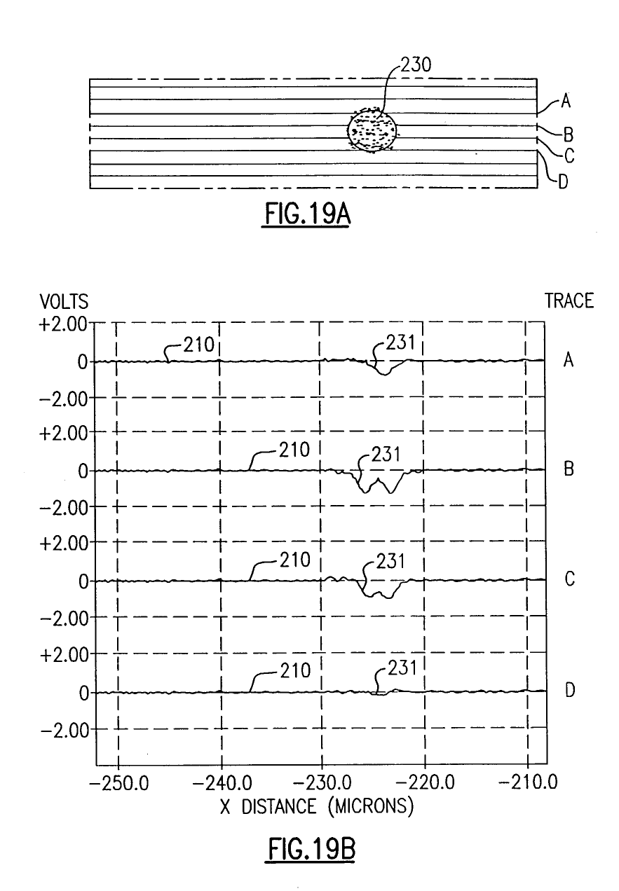

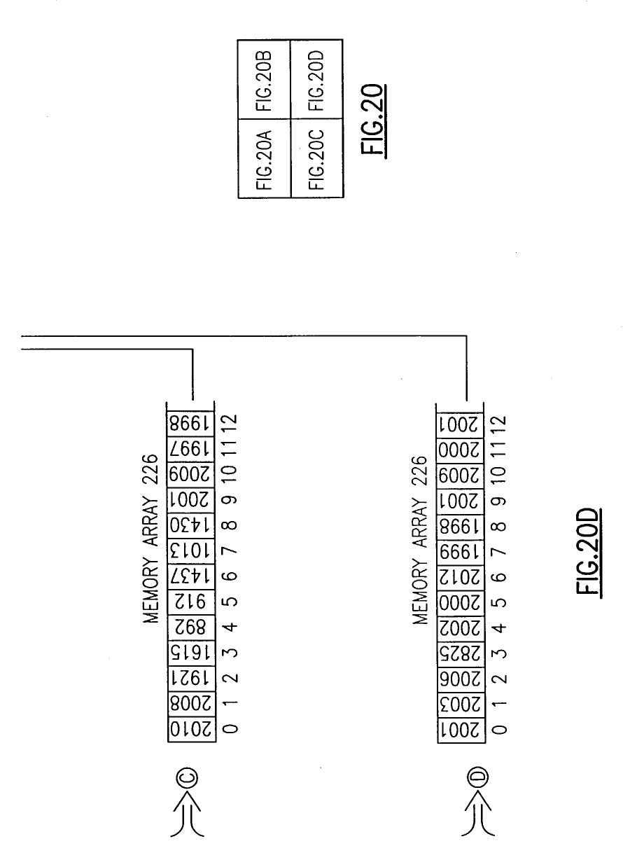

FIG. 15 is a view similar to FIG. 11 showing the entire thickness of the reflective. disc and the initial refractive property thereof. FIG. 16 is a view similar to FIG. 12 showing the entire thickness of the transmissive disc and the initial refractive property thereof. Grooves 170 are not seen in FIGS. 15 and 16 since the sections are cut along the grooves 170. FIGS. 15 and 16 show the presence of the narrow flow channel 130 that is situated perpendicular to the grooves 170 in these embodiments. FIGS. 13, 14, 15, and 16 show the entire thickness of the respective reflective and transmissive discs. In these figures, the incident beam 152 is illustrated initially interacting with the substrate 120 which has refractive properties that change the path of the incident beam as illustrated to provide focusing of the beam 152 on the reflective layer 142 or the thin semi-reflective layer 143.

Counting Methods and Related Software

By way of illustrative background, a number of methods and related algorithms for white blood cell counting using optical disc data are herein discussed in further detail. These methods and related algorithms are not limited to counting white blood cells, but may be readily applied to conducting counts of any type of particulate matter including, but not limited to, red blood cells, white blood cells, beads, and any other objects, both biological and non-biological, that produce similar optical signatures that can be detected by an optical reader.

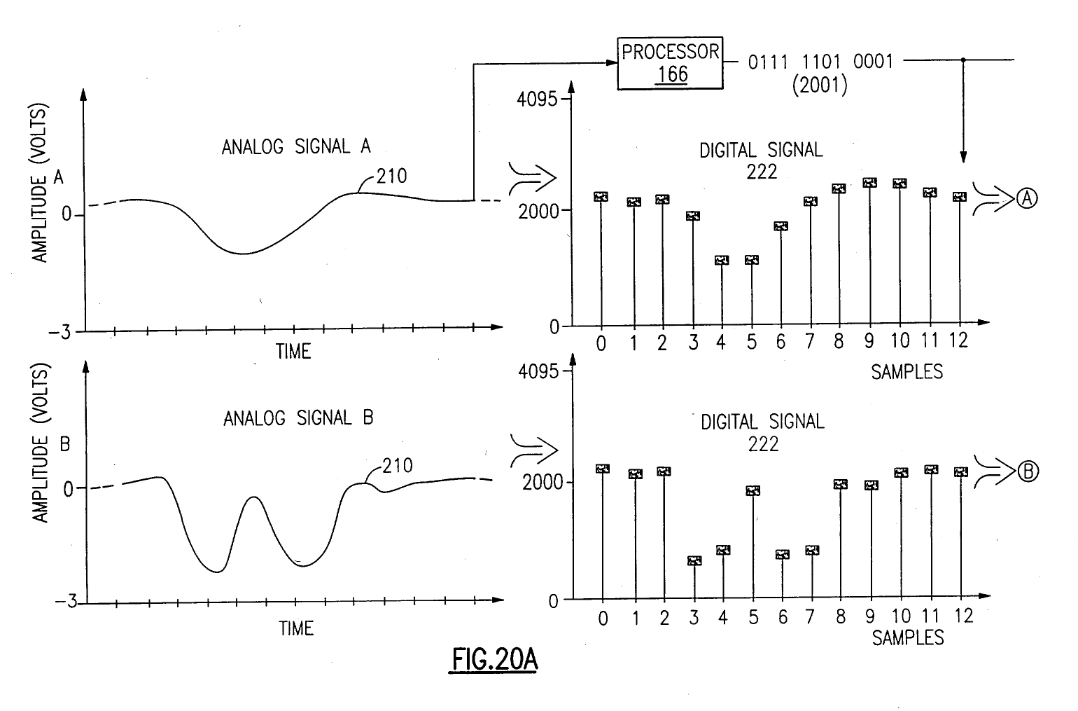

For the purposes of illustration, the following description of the methods and algorithms related to the present invention as described with reference to FIGS. 17-21, are directed to cell counting. With some modifications, these methods and algorithms can be applied to counting other types of objects similar in size to cells. The data evaluation aspects of the cell counting methods and algorithms are described generally herein to provide related background for the methods and apparatus of the present invention. Methods and algorithms for capturing and processing investigational data from the optical bio-disc has general broad applicability and has been disclosed in further detail in commonly assigned U.S. Provisional Application No. 60/291,233 entitled “Variable Sampling Control For Rendering Pixelation of Analysis Results In Optical Bio-Disc Assembly And Apparatus Relating Thereto” filed May 16, 2001 which is herein incorporated by reference and the above incorporated U.S. Provisional Application No. 60/404,921 entitled “Methods For Differential Cell Counts Including Related Apparatus And Software For Performing Same”. In the following discussion, the basic scheme of the methods and algorithms with a brief explanation is presented. As illustrated in FIG. 10, information concerning attributes of the biological test sample is retrieved from the optical bio-disc 110 in the form of a beam of electromagnetic radiation that has been modified or modulated by interaction with the test sample. In the case of the reflective optical bio-disc discussed in conjunction with FIGS. 2, 3, 4, 11, 13, and 15, the return beam 154 carries the information about the biological sample. As discussed above, such information about the biological sample is contained in the return beam essentially only when the incident beam is within the flow channel 130 or target zones 140 and thus in contact with the sample. In the reflective embodiment of the bio-disc 110, the return beam 154 may also carry information encoded in or on the reflective layer 142 or otherwise encoded in the wobble grooves 170 illustrated in FIGS. 13 and 14. As would be apparent to one of skill in the art, pre-recorded information is contained in the return beam 154 of the reflective disc with target zones, only when the corresponding incident beam is in contact with the reflective layer 142. Such information is not contained in the return beam 154 when the incident beam 152 is in an area where the information bearing reflective layer 142 has been removed or is otherwise absent. In the case of the transmissive optical bio-disc discussed in conjunction with FIGS. 5, 6, 8, 9, 12, 14, and 16, the transmitted beam 156 carries the information about the biological sample.

With continuing reference to FIG. 10, the information about the biological test sample, whether it is obtained from the return beam 154 of the reflective disc or the transmitted beam 156 of the transmissive disc, is directed to processor 166 for signal processing. This processing involves transformation of the analog signal detected by the bottom detector 157 (reflective disc) or the top detector 158 (transmissive disc) to a discrete digital form.

Referring next to FIG. 17, the signal transformation involves sampling the analog signal 210 at fixed time intervals 212, and encoding the corresponding instantaneous analog amplitude 214 of the signal as a discrete binary integer 216. Sampling is started at some start time 218 and stopped at some end time 220. The two common values associated with any analog-to-digital conversion process are sampling frequency and bit depth. The sampling frequency, also called the sampling rate, is the number of samples taken per unit time. A higher sampling frequency yields a smaller time interval 212 between consecutive samples, which results in a higher fidelity of the digital signal 222 compared to the original analog signal 210. Bit depth is the number of bits used in each sample point to encode the sampled amplitude 214 of the analog signal 210. The greater the bit depth, the better the binary integer 216 will approximate the original analog amplitude 214. In the present embodiment, the sampling rate is 8 MHz with a bit depth of 12 bits per sample, allowing an integer sample range of 0 to 4095 (0 to (2n-1), where n is the bit depth. This combination may change to accommodate the particular accuracy necessary in other embodiments. By way of example and not limitation, it may be desirable to increase sampling frequency in embodiments involving methods for counting beads, which are generally smaller than cells. The sampled data is then sent to processor 166 for analog-to-digital transformation.

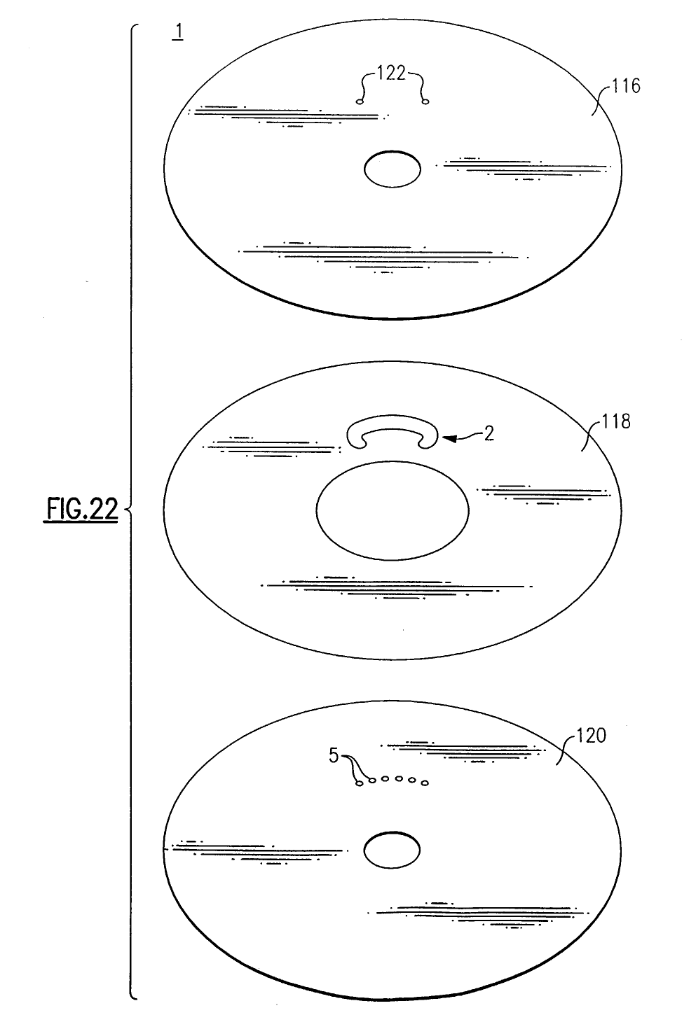

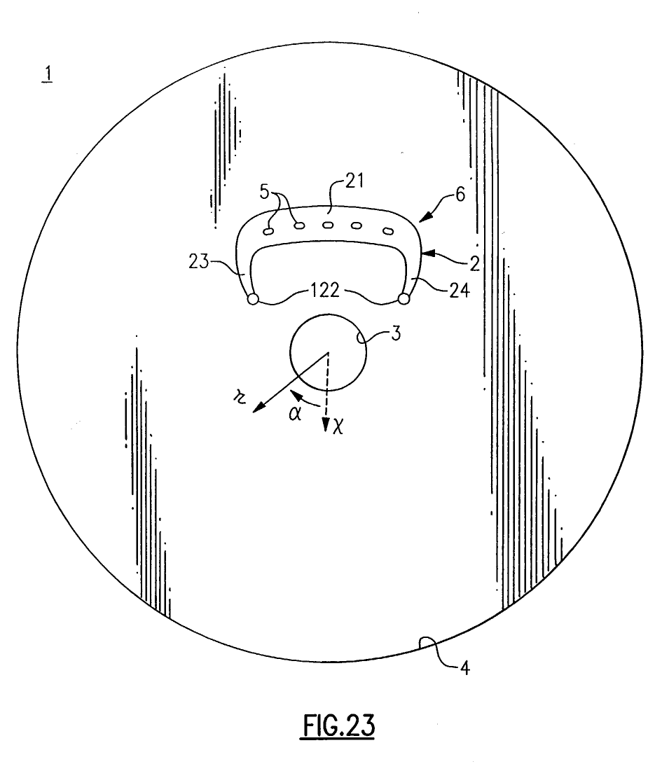

During the analog-to-digital transformation, each consecutive sample point 224 along the laser path is stored consecutively on disc or in memory as a one-dimensional array 226. Each consecutive track contributes an independent one-dimensional array, which yields a two-dimensional array 228 (FIG. 20A) that is analogous to an image.

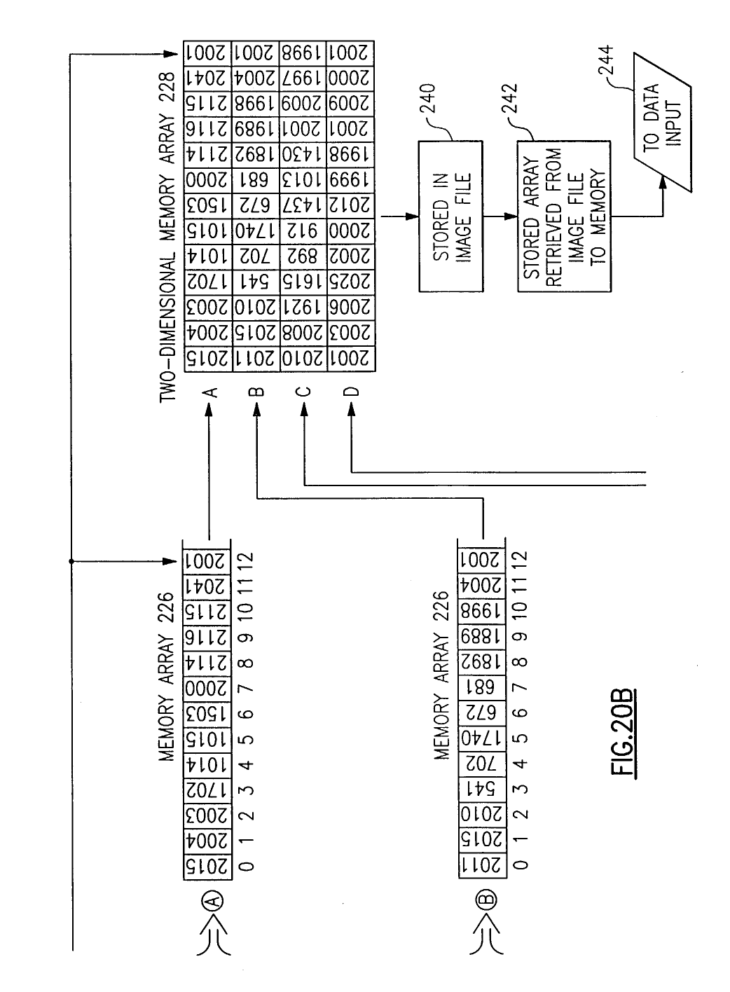

FIG. 18 is a perspective view of an optical bio-disc 110 with an enlarged detailed perspective view of the section indicated showing a captured white blood cell 230 positioned relative to the tracks 232 of the optical bio-disc. The white blood cell 230 is used herein for illustrative purposes only. As indicated above, other objects or investigational features such as beads or agglutinated matter may be utilized herewith. As shown, the interaction of incident beam 152 with white blood cell 230 yields a signal-containing beam, either in the form of a return beam 154 of the reflective disc or a transmitted beam 156 of the transmissive disc, which is detected by either of detectors 157 or 158.

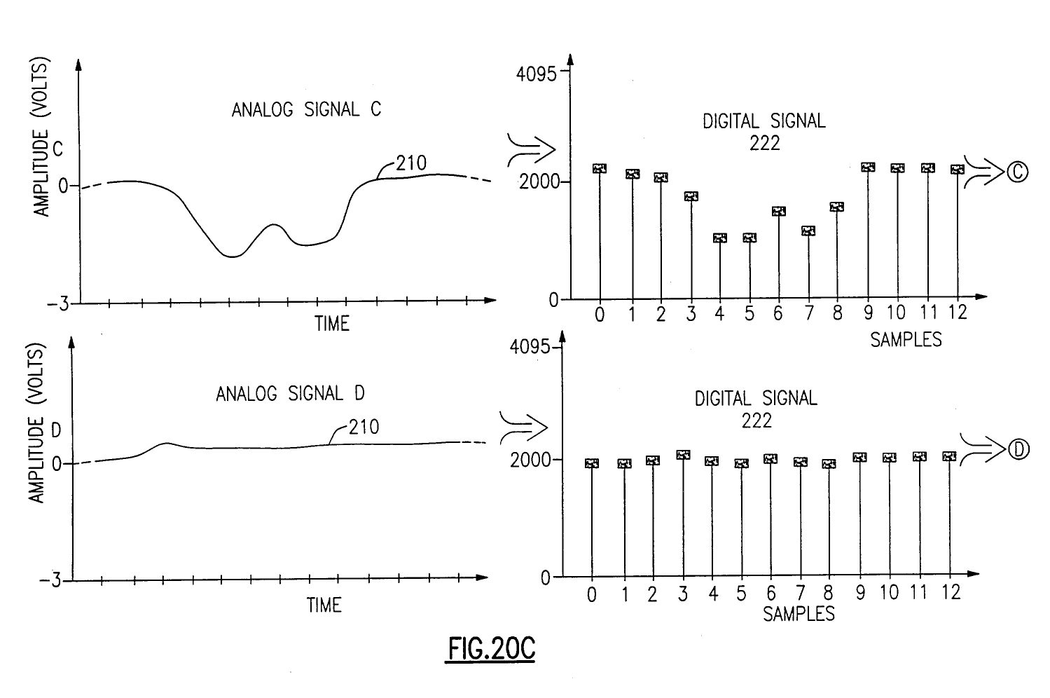

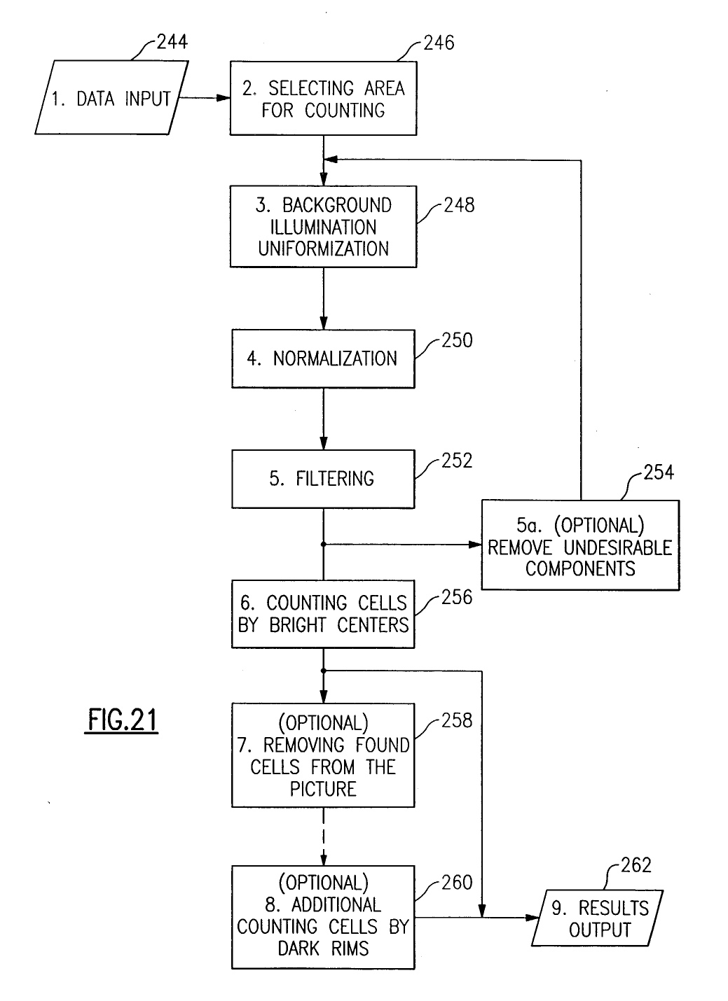

FIG. 19A is another graphical representation of the white blood cell 230 positioned relative to the tracks 232 of the optical bio-disc 110 shown in FIG. 18. As shown in FIGS. 18 and 19A, the white blood cell 230 covers approximately four tracks A, B, C, and D. FIG. 19B shows a series of signature traces derived from the white blood cell 210 of FIGS. 19 and 19A. As indicated in FIG. 19B, the detection system provides four analogue signals A, B, C, and D corresponding to tracks A, B, C, and D. As further shown in FIG. 19B, each of the analogue signals A, B, C, and D carries specific information about the white blood cell 230. Thus as illustrated, a scan over a white blood cell 230 yields distinct perturbations of the incident beam that can be detected and processed. The analog signature traces (signals) 210 are then directed to processor 166 for transformation to an analogous digital signal 222 as shown in FIGS. 20A and 20C as discussed in further detail below.

FIG. 20 is a graphical representation illustrating the relationship between FIGS. 20A, 20B, 20C, and 20D. FIGS. 20A, 20B, 20C, and 20D are pictorial graphical representations of transformation of the signature traces from FIG. 19B into digital signals 222 that are stored as one-dimensional arrays 226 and combined into a two-dimensional array 228 for data input 244.

With particular reference now to FIG. 20A, there is shown sampled analog signals 210 from tracks A and B of the optical bio-disc shown in FIGS. 18 and 19A. Processor 166 then encodes the corresponding instantaneous analog amplitude 214 of the analog signal 210 as a discrete binary integer 216 (see FIG. 17). The resulting series of data points is the digital signal 222 that is analogous to the sampled analog signal 210.

Referring next to FIG. 20B, digital signal 222 from tracks A and B (FIG. 20A) is stored as an independent one-dimensional memory array 226. Each consecutive track contributes a corresponding one-dimensional array, which when combined with the previous one-dimensional arrays, yields a two-dimensional array 228 that is analogous to an image. The digital data is then stored in memory or on disc as a two-array 228 of sample points 224 (FIG. 17) that represent the relative dimensional intensity of the return beam 154 or transmitted beam 156 (FIG. 18) at a particular point in the sample area. The two-dimensional array is then stored in memory or on disc in the form of a raw file or image file 240 as represented in FIG. 20B. The data stored in the image file 240 is then retrieved 242 to memory and used as data input 244 to analyzer 168 shown in FIG. 10.

FIG. 20C shows sampled analog signals 210 from tracks C and D of the optical bio-disc shown in FIGS. 18 and 19A. Processor 166 then encodes the corresponding instantaneous analog amplitude 214 of the analog signal 210 as a discrete binary integer 216 (FIG. 17). The resulting series of data points is the digital signal 222 that is analogous to the sampled analog signal 210.

Referring now to FIG. 20D, digital signal 222 from tracks C and D is stored as an independent one-dimensional memory array 226. Each consecutive track contributes a corresponding one-dimensional array, which when combined with the previous one-dimensional arrays, yields a two-dimensional array 228 that is analogous to an image. As above, the digital data is then stored in memory or on disc as a two-dimensional array 228 of sample points 224 (FIG. 17) that represent the relative intensity of the return beam 154 or transmitted beam 156 (FIG. 18) at a particular point in the sample area. The two-dimensional array is then stored in memory or on disc in the form of a raw file or image file 240 as shown in FIG. 20B. As indicated above, the data stored in the image file 240 is then retrieved 242 to memory and used as data input 244 to analyzer 168 FIG. 10.

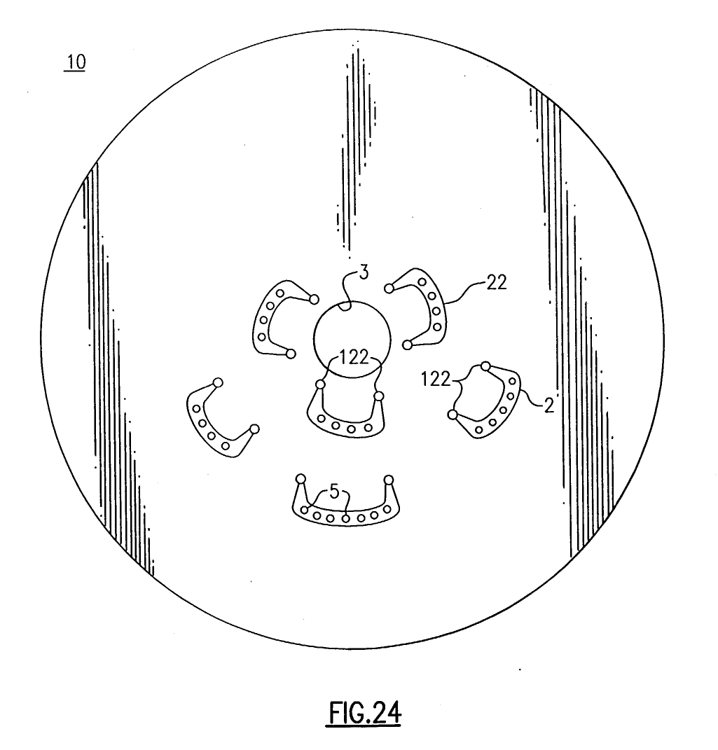

The computational and processing algorithms are stored in analyzer 168 (FIG. 10) and applied to the input data 244 to produce useful output results 262 (FIG. 21) that may be displayed on the display monitor 114 (FIG. 10).

With reference now to FIG. 21 there is shown a logic flow chart of the principal steps for data evaluation according to the processing methods and computational algorithms related to the present invention. A first principal step of the present processing method involves receipt of the input data 244. As described above, data evaluation starts with an array of integers in the range of 0 to 4096.

The next principle step 246 is selecting an area of the disc for counting. Once this area is defined, an objective then becomes making an actual count of all white blood cells contained in the defined area. The implementation of step 246 depends on the configuration of the disc and user's options. By way of example and not limitation, embodiments of the invention using discs with windows such as the target zones 140 shown in FIGS. 2 and 5, the software recognizes the windows and crops a section thereof for analysis and counting. In one preferred embodiment, such as that illustrated in FIG. 2, the target zones or windows have the shape of 1×2 mm rectangles with a semicircular section on each end thereof. In this embodiment, the software crops a standard rectangle of 1×2 mm area inside a respective window. In an aspect of this embodiment, the reader may take several consecutive sample values to compare the number of cells in several different windows.

In embodiments of the invention using a transmissive disc without windows, as shown in FIGS. 5, 6, 8, and 9, step 246 may be performed in one of two different manners. The position of the standard rectangle is chosen either by positioning its center relative to a point with fixed coordinates, or by finding reference mark which may be a spot of dark dye. In the case where a reference mark is employed, a dye with a desired contrast is deposited in a specific position on the disc with respect to two clusters of cells. The optical disc reader is then directed to skip to the center of one of the clusters of cells and the standard rectangle is then centered around the selected cluster.

As for the user options mentioned above in regard to step 246, the user may specify a desired sample area shape for cell counting, such as a rectangular area, by direct interaction with mouse selection or otherwise. In the present embodiment of the software, this involves using the mouse to click and drag a rectangle over the desired portion of the optical bio-disc-derived image that is displayed on monitor 114. Regardless of the evaluation area selection method, a respective rectangular area is evaluated for counting in the next step 248.

The third principal step in FIG. 21 is step 248, which is directed to background illumination uniformization. This process corrects possible background uniformity fluctuations caused in some hardware configurations. Background illumination uniformization offsets the intensity level of each sample point such that the overall background, or the portion of the image that is not cells, approaches a plane with an arbitrary background value Vbackground. While Vbackground may be decided in many ways, such as taking the average value over the standard rectangular sample area, in the present embodiment, the value is set to 2000. The value V at each point P of the selected rectangular sample area is replaced with the number (Vbackground+(V−average value over the neighborhood of P)) and truncated, if necessary, to fit the actual possible range of values, which is 0 to 4095 in a preferred embodiment of the present invention. The dimensions of the neighborhood are chosen to be sufficiently larger than the size of a cell and sufficiently smaller than the size of the standard rectangle.

The next step in the flow chart of FIG. 21 is a normalization step 250. In conducting normalization step 250, a linear transform is performed with the data in the standard rectangular sample area so that the average becomes 2000 with a standard deviation of 600. If necessary, the values are truncated to fit the range 0 to 4096. This step 250, as well as the background illumination uniformization step 248, makes the software less sensitive to hardware modifications and tuning. By way of example and not limitation, the signal gain in the detection circuitry, such as top detector 158 (FIG. 18), may change without significantly affecting the resultant cell counts.

As shown in FIG. 21, a filtering step 252 is next performed. For each point P in the standard rectangle, the number of points in the neighborhood of P, with dimensions smaller than indicated in step 248, with values sufficiently distinct from Vbackground is calculated. The points calculated should approximate the size of a cell in the image. If this number is large enough, the value at P remains as it was; otherwise it is assigned to Vbackground. This filtering operation is performed to remove noise, and in the optimal case only cells remain in the image while the background is uniformly equal Vbackground.

An optional step 254 directed to removing bad components may be performed as indicated in FIG. 21. Defects such as scratches, bubbles, dirt, and other similar irregularities may pass through filtering step 252. These defects may cause cell counting errors either directly or by affecting the overall distribution in the images histogram. Typically, these defects are sufficiently larger in size than cells and can be removed in step 254 as follows. First a binary image with the same dimensions as the selected region is formed. A in the binary image is defined as white, if the value at the corresponding point of the original image is equal to Vbackground, and black otherwise. Next, connected components of black points are extracted. Then subsequent erosion and expansion are applied to regularize the view of components., And finally, components that are larger than a defined threshold are removed. In one embodiment of this optional step, the component is removed from the original image by assigning the corresponding sample points in the original image with the value Vbackground. The threshold that determines which components constitute countable objects and which are to be removed is a user-defined value. This threshold may also vary depending on the investigational feature being counted i.e. white blood cells, red blood cells, or other biological matter. After optional step 254, steps 248, 250, and 252 are preferably repeated.

The next principal processing step shown in FIG. 21 is step 256, which is directed to counting cells by bright centers. The counting step 256 consists of several substeps. The first of these substeps includes performing a convolution. In this convolution substep, an auxiliary array referred to as a convolved picture is formed. The value of the convolved picture at point P is the result of integration of a picture after filtering in the circular neighborhood of P. More precisely, for one specific embodiment, the function that is integrated, is the function that equals v−2000 when v is greater than 2000 and 0 when v is less than or equal to 2000. The next substep performed in counting step 256 is finding the local maxima of the convolved picture in the neighborhood of a radius about the size of a cell. Next, duplicate local maxima with the same value in a closed neighborhood of each other are avoided. In the last substep in counting step 256, the remaining local maxima are declared to mark cells.

In some hardware configurations, some cells may appear without bright centers. In these instances, only a dark rim is visible and the following two optional steps 258 and 260 are useful.

Step 258 is directed to removing found cells from the picture. In step 258, the circular region around the center of each found cell is filled with the value 2000 so that the cells with both bright centers and dark rims would not be found twice.

Step 260 is directed to counting additional cells by dark rims. Two transforms are made with the image after step 258. In the first substep of this routine, substep (a), the value v at each point is replaced with (2000−v) and if the result is negative it is replaced with zero. In substep (b), the resulting picture is then convolved with a ring of inner radius R1 and outer radius R2. R1 and R2 are, respectively, the minimal and the maximal expected radius of a cell, the ring being shifted, subsequently, in substep (d) to the left, right, up and down. In substep (c), the results of four shifts are summed. After this transform, the image of a dark rim cell looks like a four petal flower. Finally in substep (d), maxima of the function obtained in substep (c) are found in a manner to that employed in counting step 256. They are declared to mark cells omitted in step 256.

After counting step 256, or after counting step 260 when optionally employed, the last principal step illustrated in FIG. 21 is a results output step 262. The number of cells found in the standard rectangle is displayed on the monitor 114 shown in FIGS. 1 and 5, and each cell identified is marked with a cross on the displayed optical bio-disc-derived image.

Alternative Configurations for the Optical Disc Analysis Zones

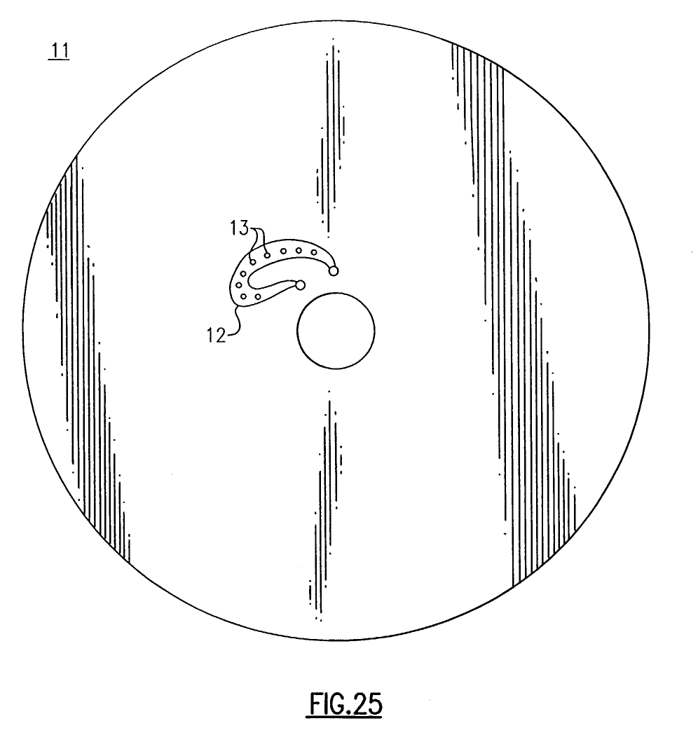

Preferred embodiments of the bio-disc according to the present invention will now be described with reference to FIGS. 22 to 39. Various features of the discs of these latter embodiments have been already illustrated with reference to FIGS. 1 to 21, and therefore such common features will not be described again in the following. Accordingly, and for the sake of simplicity, as a general rule in FIGS. 22 to 39 only the features differentiating the bio-disc from those of FIGS. 1 to 21 are represented.

Furthermore, the following description of the bio-disc of the invention can be readily applied to a transmissive-type as well as to a reflective-type optical bio-disc.

FIG. 22 is an exploded perspective view of the principal structural elements of one embodiment of the optical bio-disc according to the present invention, which in the present case is globally indicated by 1.

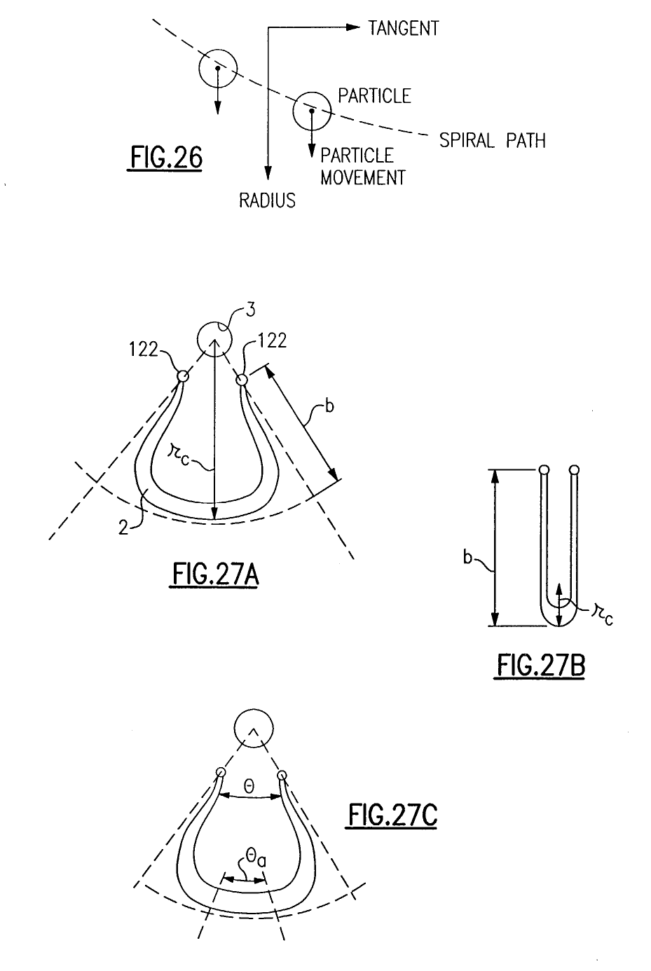

FIG. 23 is a top plan view of bio-disc 1, wherein a cap portion 116 thereof is represented as transparent in order to reveal internal components of disc 1 itself.

With reference to FIGS. 22 and 23, optical bio-disc 1 includes the principal structural elements already introduced with reference to the preceding figures, namely the aforementioned cap portion 116, an adhesive member or channel layer 118 and a substrate 120.

The cap portion 116 includes one or more inlet ports 122. Purely by way of example and for the sake of simplicity, in FIGS. 22 and 23 only two inlet ports 122 are shown.

The adhesive member or channel layer 118 has fluid chambers 2 formed therein, in which inspection of investigational features can be conducted and which will be described in greater detail hereinbelow. Always by way of example and for the sake of simplicity, in FIGS. 22 and 23 only one fluid chamber 2 is shown.

The substrate 120 defines a circular inner perimeter 3 and a circular outer perimeter 4, concentric with the inner perimeter 3, of bio-disc 1.

The substrate 120 includes one or more reaction sites 5. In FIGS. 22 and 23 a disc including only a single set, or array, of reaction sites 5 is shown purely by way of example and for illustrative purposes only.

The skilled person will understand that reaction sites 5 may be in general target or capture zones. As already illustrated with reference to FIGS. 1 to 21, such target zones may be formed by physically removing an area or portion of a reflective or semi-reflective layer of the disc at a desired location or, alternatively, by masking the desired area prior to applying the reflective or semi-reflective layer. Alternatively, as already illustrated above, in the transmissive-type disc target zones may be created by silk screening ink onto the thin semi-reflective layer or they may be defined by address information encoded on the disc.

Bio-disc 1 also provides, at substrate 120, a series of information tracks analogous to the tracks 170 already described with reference to the embodiments of FIGS. 1 to 21 and which are therefore not represented in FIGS. 22 and 23.

In general, information tracks are of a substantially circular profile and increase in circumference as a function of radius extending from the inner perimeter 3 to the outer perimeter 4 of disc 1, typically according to a spiral profile.

Furthermore, bio-disc 1 may provide an operational layer associated with substrate 120, which layer includes encoded information located substantially along one or more information tracks, e.g. a layer analogous to the reflective layer 142 introduced with reference to FIGS. 1 to 21.

A more detailed description of fluid chamber 2 will now be provided, with reference to FIGS. 22 and 23.

First of all, it will be understood that bio-disc 1 provides, in correspondence of fluid chamber 2, an analysis area or zone, globally indicated by 6, including investigational features.

The analysis zone addressed by the present invention may include any type of reaction site(s), array(s) of spot, capture site(s) or zone(s), target zone(s), viewing window(s) and the like, and, in general, it can be any target analysis zone of whatever type, nature, and construction.

According to the general teaching of the present invention, the analysis zone 6, and therefore the fluid chamber 2, has a configuration alternative to that of the embodiments described with reference to FIGS. 1 to 21. This alternative configuration is such that when an incident beam of electromagnetic energy tracks along the information tracks, any investigational features within the analysis zone 6 are thereby interrogated following a varying angular coordinate, instead of that which is along a single radius (i.e. at a fixed angular coordinate) as in the embodiments of FIGS. 1 to 21.

As it can be easily understood and as it is shown in FIG. 23, by “angular coordinate” is herewith intended the planar angle cc defined, in a plan view of disc 1, between a disc reference radial axis x and the disc radial axis r corresponding to the actual radial position of an element, e.g. an investigational feature, wherein the center of the reference system is of course set at the center of disc 1 itself. Analogously, by “radial coordinate” it is herewith intended the actual position of an element, e.g. an investigational feature, along the corresponding radial axis r.

According to a preferred embodiment, the analysis zone 6 is directed substantially along the information tracks.

In the specific embodiment shown in FIGS. 22 and 23, the fluid chamber 2 is a fluidic circuit or channel having a central portion 21 extending according to a substantially circumferential profile concentric with respect to disc inner and outer perimeter 3 and 4, and two lateral arm portions 23 and 24 extending along a substantially radial direction.

Reaction sites 5 are thus distributed along the circumferential extension of the fluid channel central portion 21, i.e. substantially along an arc of circumference. Therefore, according to the invention, reaction sites 5 are not arranged along a single radius, i.e. at a single angular coordinate, as in previous embodiments, but at a varying angular coordinate at fixed radius.

Accordingly, when an incident beam of electromagnetic energy tracks along the information tracks, the investigational features within the analysis zone 6 are thereby interrogated according to a substantially circumferential path.

In the following, this circumferential arrangement will be referred to as “equi-radial (eRad)”, and the disc providing it as an “eRad disc”. Thus, for purposes of convenience, the terms “equi-radial”, “e-radial”, “e-rad”, or “eRad” may be utilized herein interchangeably.

An issue arising from the use of eRad disc 1 is the positioning of the inlet ports 122 on disc itself. As shown in FIG. 23, it is possible to have inlet ports 122 at a different radial position with respect to the circumferential portion 21 of the corresponding channel 2. However, preferably channel central portion 21 is at a higher radial coordinate with respect to the inlet ports 122, in order to prevent the centripetal forces inducing a liquid eventually contained in the channel to escape from the ports 122.

According to a variant embodiment it would also be possible to have the channel central portion at a lower radius than the inlet ports, provided that these ports are sealed, i.e. guaranteed not to leak.

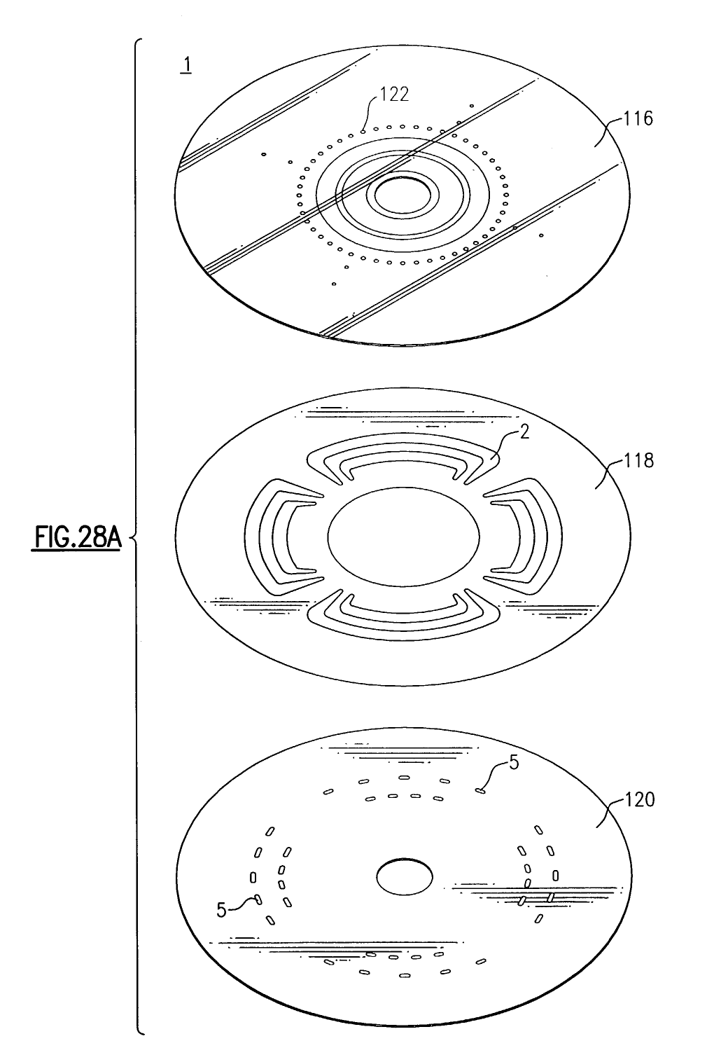

FIG. 24 shows a top plan view of another preferred embodiment of bio-disc according to the invention, here denoted by 10, with a cap portion thereof represented as transparent in order to reveal internal components of disc 10 itself.

As illustrated in FIG. 24, disc 10 provides a plurality of equi-radial fluid channels 2, arranged in multiple tiers concentric with a disc internal perimeter 3, and corresponding arrays of reaction sites 5.

Disc 10 provides also concentric arrays of inlet ports 122. As discussed above, it is not necessary for all these inlet ports 122 to be positioned at a single, usually small, radial coordinate, provided that, preferably, the inlet ports 122 associated with a certain channel 2 are arranged at a lower radial coordinate with respect to the circumferential portion of the channel itself.

The disc embodiment of FIG. 24 allows overcoming a potential limitation of discs that utilize reaction sites at a single radial coordinate, i.e. the fact that in this latter case there is a smaller number of sets of reactions or analysis that can be fitted into a single radius of the disc.

It will be appreciated that eRad discs described so far provide the advantage of a very rapid read out of the data, since a much reduced radial extent must be covered by both the light source and the detectors of the disc drive system in order to detect all reaction sites.

Furthermore, the distances required for unbound cells or, in general, for detection particles to be clear of the reaction regions are small compared with known art radial discs. Moreover, such unbound particles do not move over other reaction regions.

In addition, eRad discs make possible to use a disc drive system having a detector of limited size.

Another advantage of the eRad discs according to the invention is that centripetal force is constant over all the reaction sites or target regions.

Still another advantage of eRad discs compared to the known art discs is that smaller radial extensions of the disc are occupied, leading to a larger distance between the edge of the channel and the edge of the disc, so that better bonding and reduced chance of leaks are achieved.

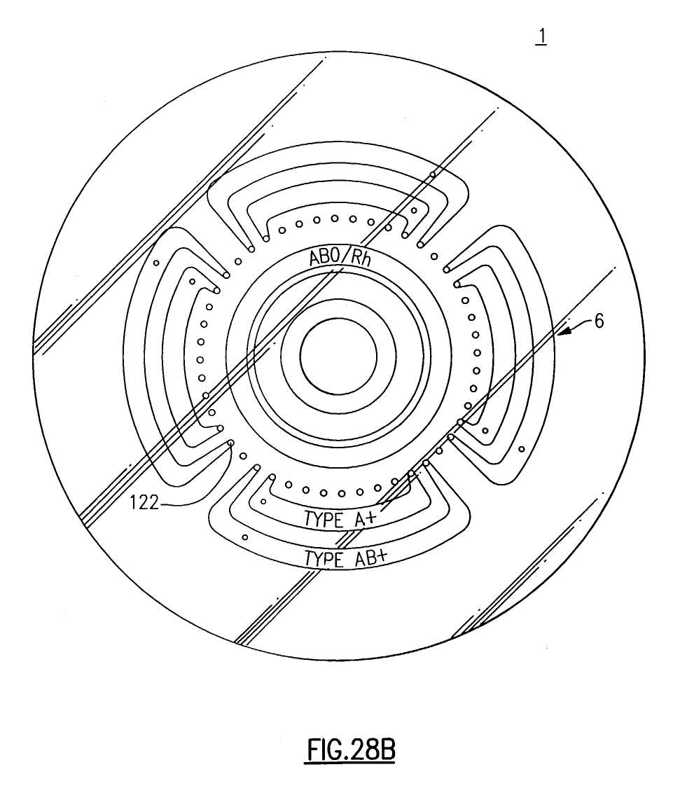

FIG. 25 shows a top plan view of another preferred embodiment of bio-disc according to the present invention, here denoted by 11, in which a cap portion of the disc itself is represented as transparent in order to reveal disc internal components.

With reference to FIG. 25, disc 11 includes a fluid chambers 12, and therefore an analysis zone, extending along a path developing according to varying angular and radial coordinates, and in particular according to a spiral. Therefore, this embodiment provides also reaction sites, or target zones, 13 distributed according to the same spiral path.

Preferably, the spiral analysis zone of the present embodiment is circumferentially elongated between a pre-selected number of circular information tracks of disc 11, and the investigational features are interrogated substantially along the circular information tracks between a pre-selected inner and outer circumference.

The spiral arrangement merges the advantages of the known art radial solution with the eRad solution mentioned above. In fact, the spiral configuration of the analysis zone implies a much-reduced radial extension of the analysis zone itself and a consequent smaller variation in centripetal force with respect to the radial solution, at the same time allowing to obtain a larger number of channels on the disc with respect to the eRad solution.

Furthermore, in this spiral arrangement, and in general in arrangements providing both a varying angular coordinate and a varying radial coordinate for each analysis zone, the individual chambers, or channels, can be made longer than in the eRad solution, thereby allowing to obtain a greater number of target zones or reaction sites, e.g. for duplication or calibration purposes.

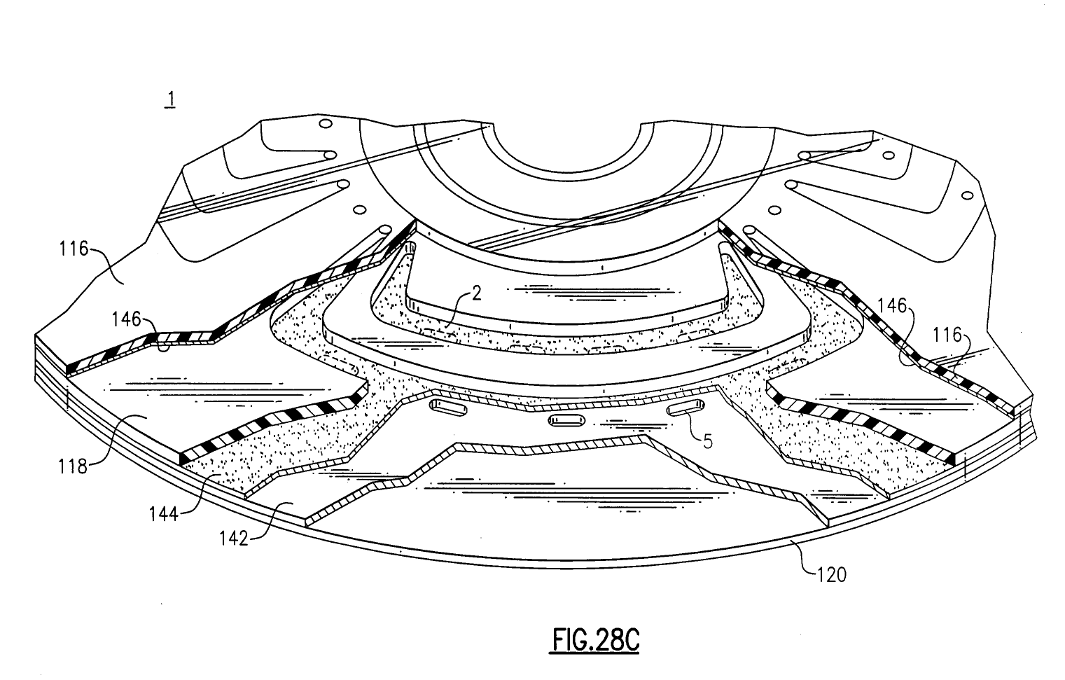

Moreover, as depicted schematically in FIG. 26, if the spiral path has a shallow angle, unbound particles, e.g. cells, beads and the like, still do not cross other target zones, e.g. other reaction sites.

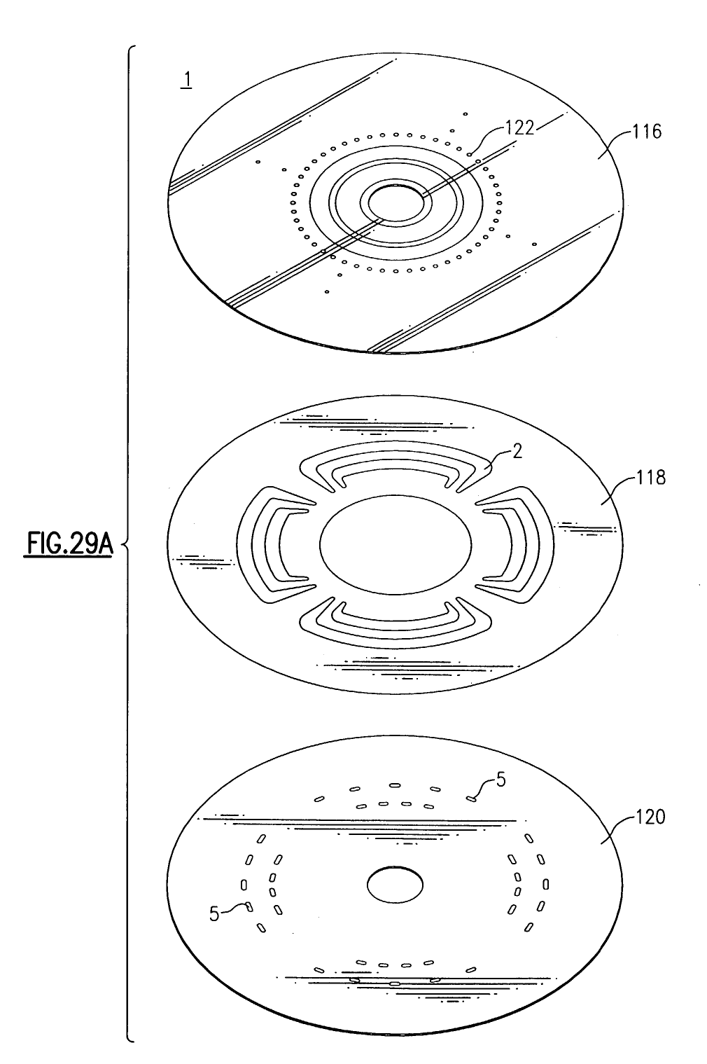

With specific reference to liquid containing chambers or channels, FIGS. 27A to 27C relate to a preferred choice of corresponding construction parameters.

Although FIGS. 27A to 27C show the circumferential channel 2 of bio-disc 1 described with reference to FIGS. 22 and 23, the same considerations may apply for all the embodiments of the invention, i.e. for every disc having an analysis zone apt to be interrogated according to a varying angular coordinate.

Independently from the specific embodiment considered, a person skilled in the art understands that the maximum pressure on the wall of a fluid chamber is at the portion of the chamber itself corresponding to the maximal radial coordinate, due to the hydrostatic pressure in the liquid column caused by the rotation of the disc.

With reference to FIG. 27A, in order to limit leaks the length of the column of liquid, indicated by b and directly related to the radial extension of the channel, should be small compared to the area over which the pressure is applied, which is related to the radius of curvature of the channel at the maximum radius, denoted by r_{c}. If the ratio rib of these two variables is small, then the pressure at the end of the channel will be high, and the chance of leaks is high. Therefore, preferably this aspect ratio is to be kept as high as possible. In particular, preferably channels should have a ratio r_{c}/b equal to or greater than 0.5 in order to reduce the chance of leaks. More preferably, this ratio should be equal or greater than 1.

Fig.27B allows a comparison between the ratio r_{c}/b in the case of a channel developing according to a substantial constant angular coordinate, e.g. the radial channel of the embodiments described in conjunction with FIGS. 1 to 21, and the channel developing according to a varying angular coordinate of the present invention.

With reference to FIG. 27C, as a further preferred condition, the angular extension θₐ of the channel length with a radius of curvature substantially similar to r_{c} should be in a ratio of at least 0.25 with the angle θ between radially directed arms of the channel itself, otherwise the area over which the force of the liquid column is exerted is still too high.

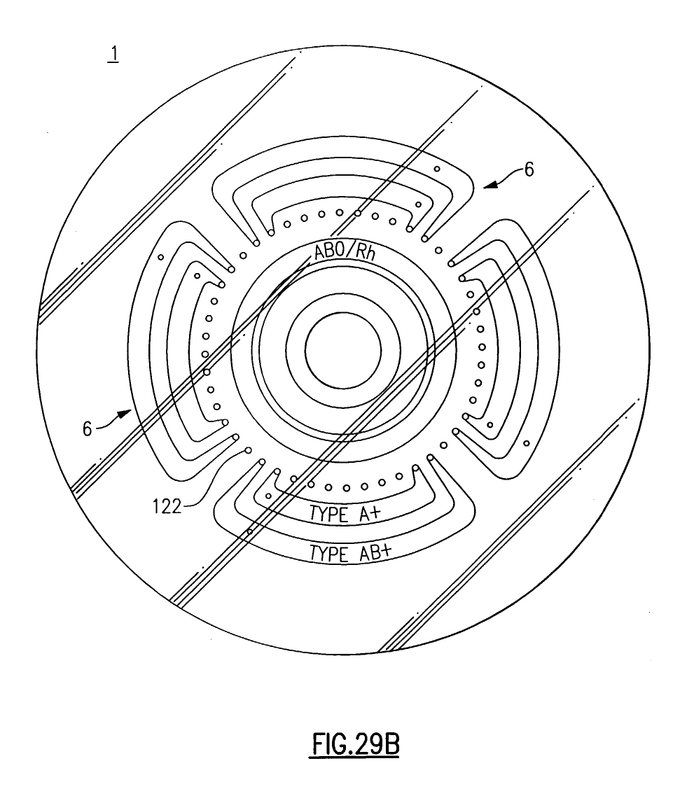

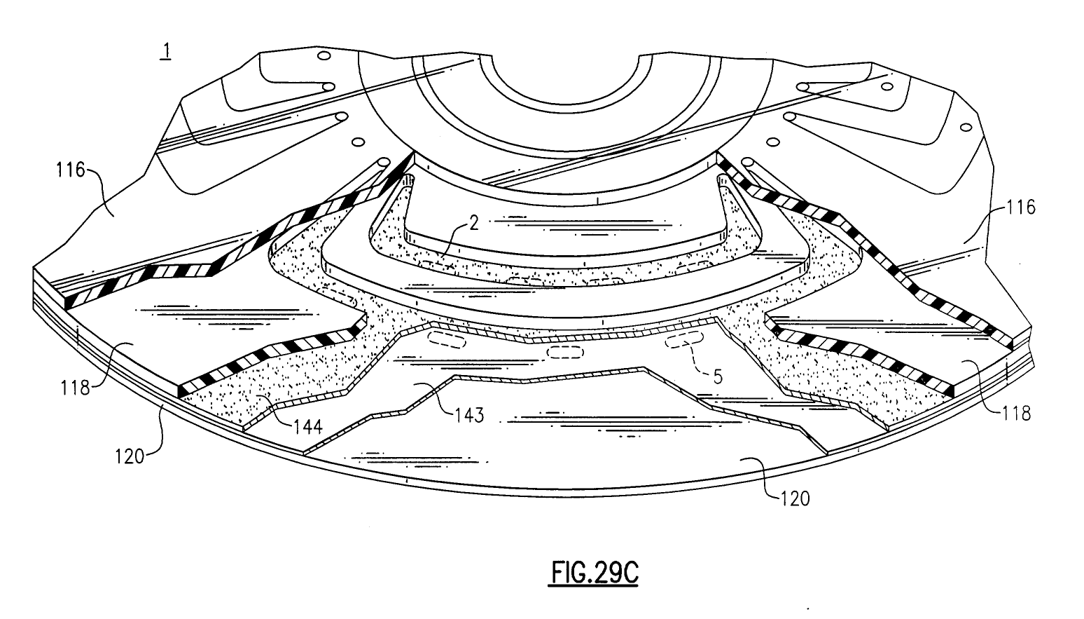

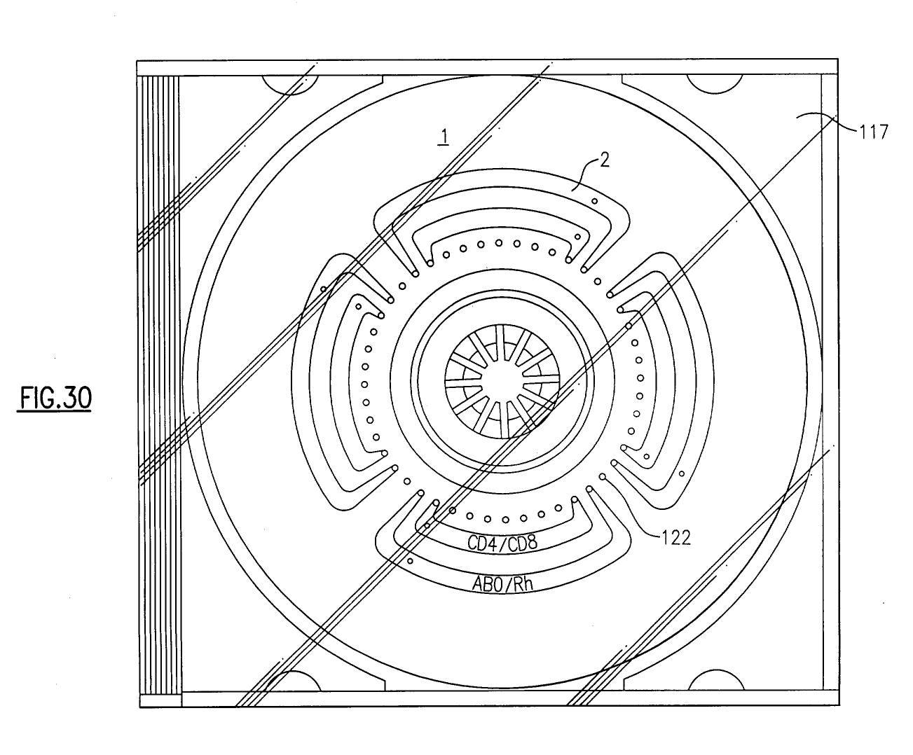

Additional embodiments, aspects, details, and attributes of the present invention are shown in FIGS. 28 to 39.

FIGS. 28A is an exploded perspective view of a reflective bio-disc incorporating the equi-radial channels of the present invention. This general construction corresponds to the radial-channel disc shown in FIG. 2. The e-rad implementation of the bio-disc 1 shown in FIG. 28A similarly includes the cap 116, the channel layer 118, and the substrate 120. The channel layer 118 includes the equi-radial fluid channels 2, while the substrate 120 includes the corresponding arrays of reaction sites 5.

FIG. 28B is a top plan view of the disc shown in FIG. 28A. FIG. 28B further shows a top plan view of an embodiment of eRad disc with a transparent cap portion, which disc has two tiers of circumferential fluid channels with ABO chemistry and two blood types (A+ and AB+). As shown in FIG. 28B, it is also possible to provide a priori, at the manufacturing stage of the disc of the invention, a plurality of entry ports, eventually at different radial coordinate, so that a range of equi-radial, spiralling, or radial reaction sites and/or channels are possible on one disc. These channels can be used for different test suites, or for multiple samples of single test suites.

FIG. 28C is a perspective view of the disc illustrated in FIG. 28A with cut-away sections showing the different layers of the e-radial reflective disc. This view is similar to the reflective disc 110 shown in FIG. 4. The e-rad implementation of the reflective bio-disc 1 shown in FIG. 28C similarly includes the reflective layer 142, active layer 144 as applied over the reflective layer 142, and the reflective layer 146 on the cap portion 116.

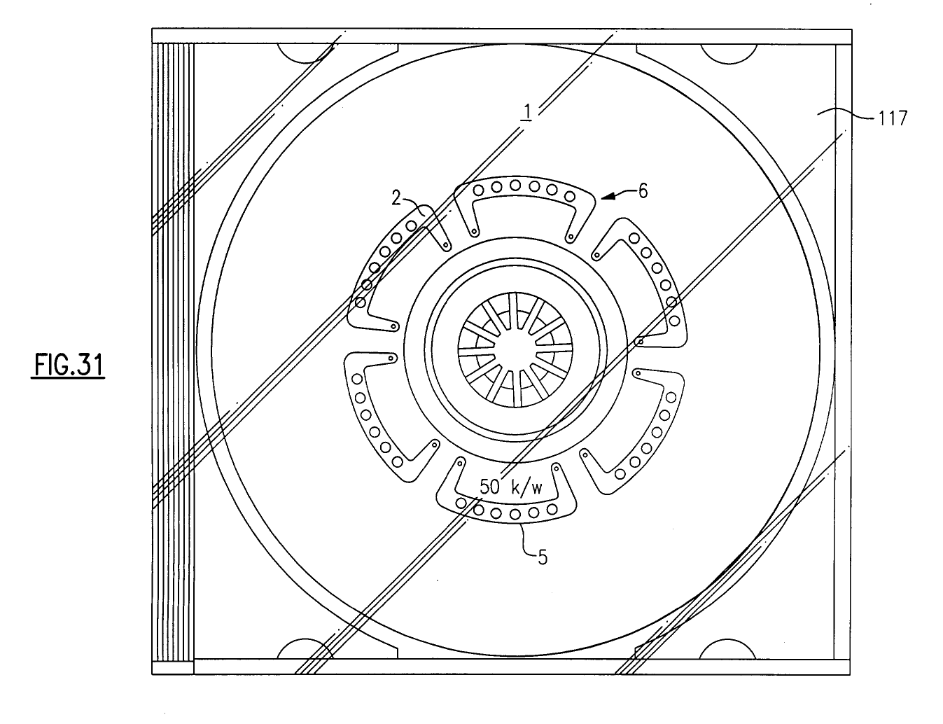

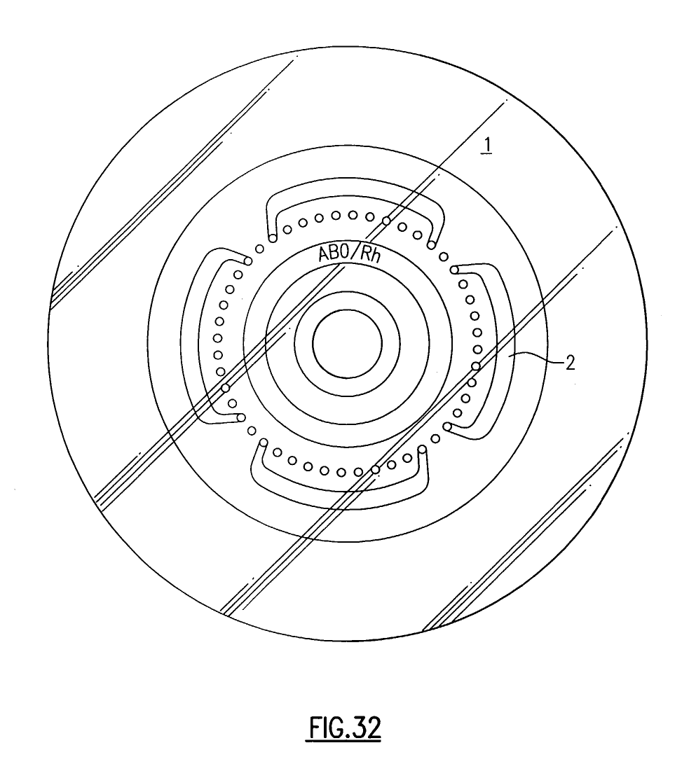

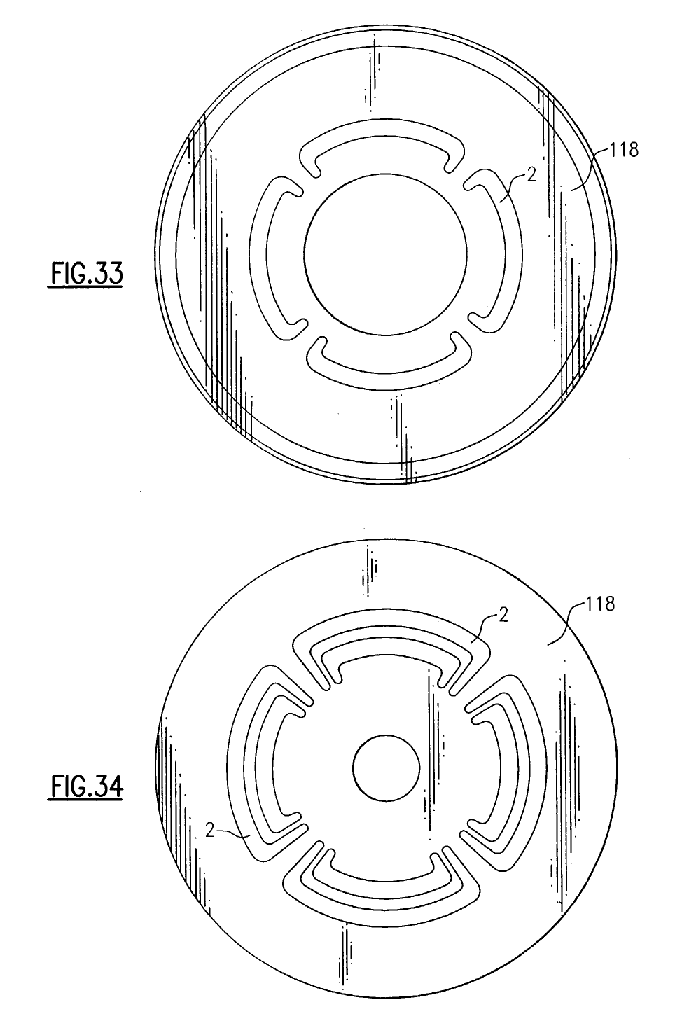

FIGS. 29A is an exploded perspective view of a transmissive bio-disc utilizing the e-radial channels of the present invention. This general construction corresponds to the radial-channel disc shown in FIG. 5. The transmissive e-rad implementation of the bio-disc 1 shown in FIG. 29A similarly includes the cap 116, the channel layer 118, and the substrate 120. The channel layer 118 includes the equi-radial fluid channels 2, while the substrate 120 includes the corresponding arrays of reaction sites 5.

FIG. 29B is a top plan view of the transmissive r-rad disc shown in FIG. 29A. FIG. 29B further shows two tiers of circumferential fluid channels with ABO chemistry and two blood types (A+ and AB+). As previously discussed, the assays are performed in the analysis zones 6.

FIG. 29C is a perspective view of the disc illustrated in FIG. 29A with cut-away sections showing the different layers of this embodiment of the e-rad transmissive bio-disc. This view is similar to the transmissive disc 110 shown in FIG. 9. The e-rad implementation of the transmissive bio-disc 1 shown in FIG. 29C similarly includes the thin semi-reflective layer 143 and the active layer 144 as applied over the thin semi-reflective layer 143.

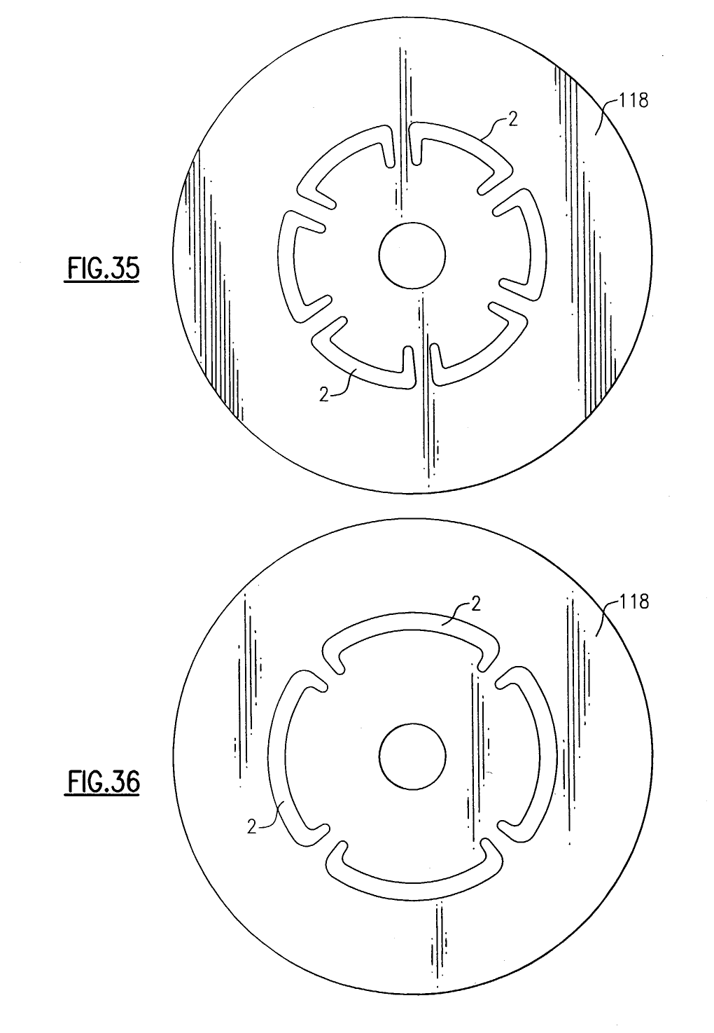

FIG. 30 shows a top plan view of an embodiment of eRad disc with a transparent cap portion, which disc has two tiers of circumferential fluid channels with two different assays, namely CD4/CD8 chemistry and ABO/RH chemistry. The disc 1 is illustrated in a bio-safe jewel case 117.

FIG. 31 shows a top plan view of an embodiment of CD4/CD8 eRad disc with a transparent cap portion, which disc has six circumferential fluid channels arranged at substantially the same radial coordinate and including with three concentrations of cultured cells. The disc 1 of FIG. 31 is also illustrated in the bio-safe jewel case 117.

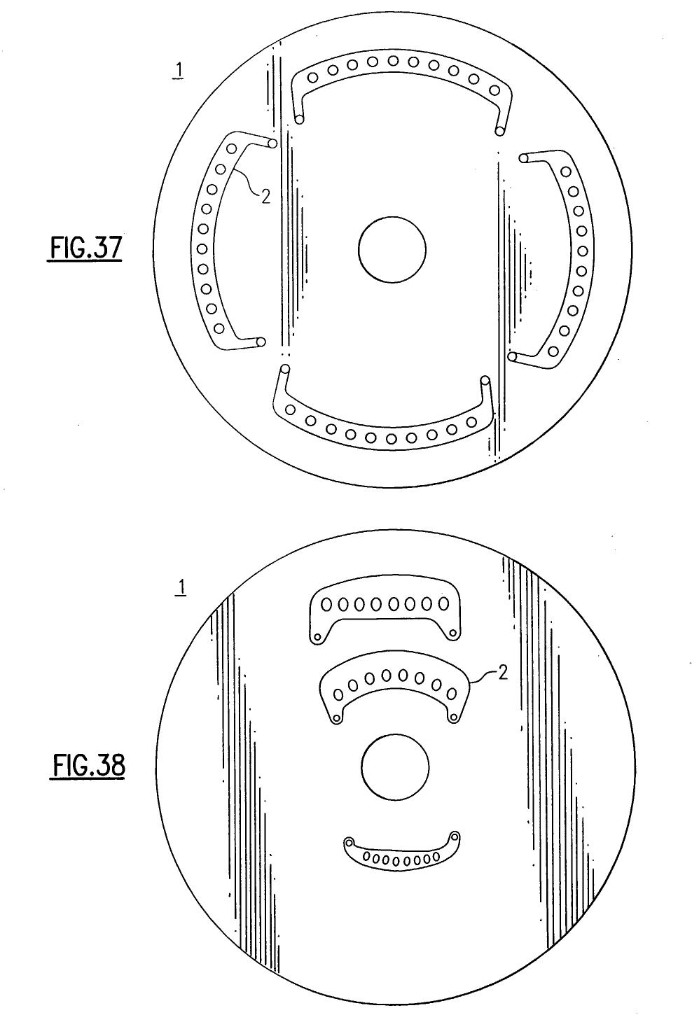

FIG. 32 shows a top plan view of an embodiment of eRad disc with a transparent cap portion, which disc 1 has four circumferential fluid channels 2 arranged at substantially the same radial coordinate.

FIG. 33 shows a top plan view of an embodiment of an adhesive member or channel layer 118 of eRad disc having four circumferential fluid channels 2 arranged at substantially the same radial coordinate. Preferably, the adhesive layer has a thickness of about 80 microns and is made of a silkscreen pressure sensitive adhesive material.

FIG. 34 shows a top plan view of an embodiment of an adhesive member or channel layer 118 of eRad disc having two tiers of four circumferential fluidic channels each. Preferably, the adhesive layer has a thickness of about 100 microns and is made of a pressure sensitive adhesive material.

FIG. 35 shows a top plan view of an embodiment of an adhesive member or channel layer 118 of eRad disc having six circumferential fluid channels 2 arranged at substantially the same radial coordinate. Preferably, the adhesive layer has a thickness of about 100 microns and is made of a pressure sensitive adhesive material.

FIG. 36 shows a top plan view of another embodiment of an adhesive member or channel layer 118 of eRad disc having four circumferential fluid channels 2 arranged at substantially the same radial coordinate. Preferably, the adhesive layer has a thickness of about 100 microns and is made of a pressure sensitive adhesive material.

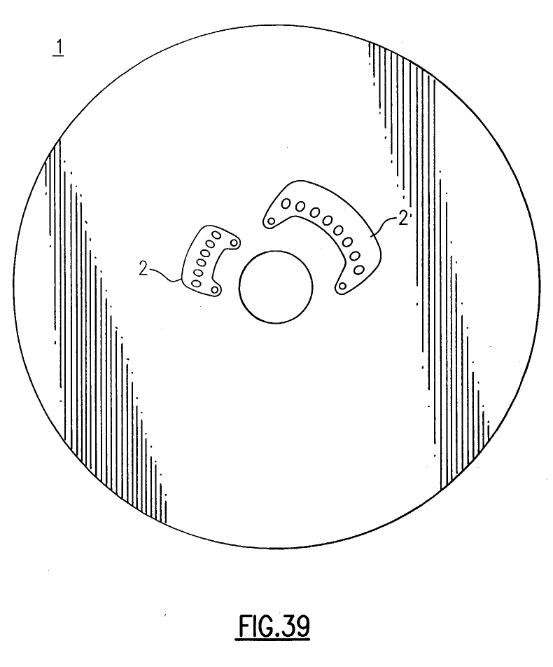

FIG. 37 shows a schematic top plan view of an embodiment of eRad disc 1 wherein a cap portion thereof is represented as transparent, which disc has four circumferential fluid channels 2 arranged at substantially the same radial coordinate, each including respective reaction sites apt to be interrogated according to a circumferential path. 1

FIG. 38 shows a schematic top plan view of an alternative embodiment of eRad disc 1 wherein a cap portion thereof is represented as transparent, which disc has three circumferential fluid channels 2 arranged asymmetrically, and in particular arranged at different radial coordinates.

FIG. 39 shows a schematic top plan view of an alternative embodiment of eRad disc 1 wherein a cap portion thereof is represented as transparent, which disc has two circumferential fluid channels 2 of different size.

The invention also provides an optical analysis disc drive system of the type described in conjunction with FIGS. 1 and 10, including interrogation means of the investigational features, and in particular the light source, optical detector(s) and associated optical components already described above in conjunction with FIG. 10.

According to the invention, the interrogation means are adapted to interrogate the investigational features within the disc analysis zone according to a varying angular coordinate, and preferably circumferentially or spirally.

Preferably, the arrangement of the disc and of the system is such that rotation of the disc itself distributes investigational features in a substantially consistent distribution along the chamber.

More preferably, rotation of the disc distributes the concentration of investigational features in a substantially even distribution along the analysis chamber.

The invention also provides an analysis method using a bio-disc and an optical disc drive system as described so far, which method provides an interrogation step of the disc investigational features such that when an incident beam of electromagnetic energy tracks along disc information tracks, any investigational features within the analysis zone are thereby interrogated according to a varying angular coordinate, and in particular according to a circumferential or spiral path.

Concluding Statements

All patents, provisional applications, patent applications, and other publications mentioned in this specification are incorporated herein in their entireties by reference.

While this invention has been described in detail with reference to a certain preferred embodiments, it should be appreciated that the present invention is not limited to those precise embodiments. Rather, in view of the present disclosure that describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

Furthermore, in view of the present disclosure, those skilled in the art will recognize, or be able to ascertain, using no more than routine experimentation, many equivalents to the specific embodiments of the invention described herein. Such equivalents are also intended to be encompassed by the following claims.

1. An optical analysis disc, comprising:
a substrate having an inner perimeter and an outer perimeter;
an operational layer associated with said substrate, said operational layer including encoded information located substantially along information tracks; and
an analysis area including investigational features, said analysis area being positioned between said inner perimeter and said outer perimeter of said substrate and directed along said information tracks so that when an incident beam of electromagnetic energy tracks along said information tracks, any investigational features within the analysis area are thereby interrogated circumferentially.

2. An optical analysis disc, comprising:
a substrate having an inner perimeter and an outer perimeter;
an operational layer associated with said substrate, said operational layer including encoded information located substantially along information tracks; and
an analysis area including investigational features, said analysis area being positioned between said inner perimeter and said outer perimeter of said substrate and directed along said information tracks so that when an incident beam of electromagnetic energy tracks along said information tracks, any investigational features within the analysis area are thereby interrogated according to a spiral path.

3. An optical analysis disc, comprising:
a substrate having an inner perimeter and an outer perimeter;
an operational layer associated with said substrate, said operational layer including encoded information located substantially along information tracks; and
an analysis area including investigational features, said analysis area being positioned between said inner perimeter and said outer perimeter of said substrate and directed along said information tracks so that when an incident beam of electromagnetic energy tracks along said information tracks, any investigational features within the analysis area are thereby interrogated according to a path of varying angular coordinate.

4. The optical analysis disc according to claim 1 wherein said substrate includes a series of substantially circular information tracks that increase in circumference as a function of radius extending from said inner perimeter to said outer perimeter.

5. The optical analysis disc according to claim 4 wherein said analysis area is circumferentially elongated between a pre-selected number of circular information tracks.

6. The optical analysis disc according to claim 5 wherein said investigational features are interrogated substantially along said circular information tracks between a pre-selected inner and outer circumference.

7. The optical analysis disc according to claim 1 wherein said analysis area includes a fluid chamber.

8. The optical analysis bio-disc according to claim 1 wherein rotation of said disc distributes investigational features in a substantially consistent distribution along said analysis area.

9. The optical analysis disc according to claim 1 wherein rotation of said disc distributes the concentration of investigational features in a substantially even distribution along said analysis area.

10. An optical analysis disc, comprising:
a substrate having an inner perimeter and an outer perimeter; and
an analysis zone including investigational features, said analysis zone being positioned between said inner perimeter and said outer perimeter of said substrate and extending according to a varying angular coordinate.

11. An optical analysis disc, comprising:
a substrate having an inner perimeter and an outer perimeter; and
an analysis zone including investigational features, said analysis zone being positioned between said inner perimeter and said outer perimeter of said substrate and extending according to a varying angular and radial coordinate.

12. An optical analysis disc, comprising:
a substrate having an inner perimeter and an outer perimeter; and
an analysis zone including investigational features, said analysis zone being positioned between said inner perimeter and said outer perimeter of said substrate and extending according to a varying angular coordinate and at a substantially fixed radial coordinate.

13. An optical analysis disc, comprising:
a substrate having an inner perimeter and an outer perimeter;
an analysis zone including investigational features, said analysis zone being positioned between said inner perimeter and said outer perimeter of said substrate and extending according to a substantially circumferential path.

14. An optical analysis disc, comprising:
a substrate having an inner perimeter and an outer perimeter;
an analysis zone including investigational features, said analysis zone being positioned between said inner perimeter and said outer perimeter of said substrate and extending according to a substantially spiral path.

15. The optical analysis disc according to claim 10 further comprising an operational layer associated with said substrate, said operational layer including encoded information located substantially along information tracks.

16. The optical analysis disc according to claim 10 wherein said substrate includes a series of information tracks and said analysis zone is directed substantially along said information tracks, so that when an incident beam of electromagnetic energy tracks along said information tracks, any investigational features within the analysis zone are thereby interrogated circumferentially.

17. The optical analysis disc according to claim 16 wherein said information tracks are substantially circular and increase in circumference as a function of radius extending from said inner perimeter to said outer perimeter.

18. The optical analysis disc according to claim 17 wherein said analysis zone is circumferentially elongated between a pre-selected number of circular information tracks.

19. The optical analysis disc according to claim 18 wherein said investigational features are interrogated substantially along said circular information tracks between a pre-selected inner and outer circumference.

20. The optical analysis disc according to claim 10 wherein said analysis zone comprises a plurality of reaction sites arranged according to a varying angular coordinate.

21. The optical analysis disc according to claim 10 wherein said analysis zone comprises a plurality of capture or target zones arranged according to a varying angular coordinate.

22. The optical analysis disc according to claim 10 comprising a plurality of analysis zones positioned between said inner perimeter and said outer perimeter of said substrate, wherein at least one analysis zone of said plurality extends according to a varying angular coordinate.

23. The optical analysis disc according to claim 22 wherein the analysis zones of said plurality extend according to a substantially circumferential path and are concentrically arranged around said bio-disc inner perimeter.

24. The optical analysis disc according to claim 22 further comprising multiple tiers of analysis zones.

25. The optical analysis disc according to claim 24 wherein each analysis zone extends according to a substantially circumferential path and each tier is arranged onto the disc at a respective radial coordinate.

26. The optical analysis disc according to claim 10 wherein said analysis zone comprises at least one fluid chamber extending according to a varying angular coordinate.

27. The optical analysis disc according to claim 26 wherein said at least one fluid chamber has a central portion extending according to a varying angular coordinate, and two lateral arm portions extending according to a substantially radial direction.

28. The optical analysis disc according to claim 27 wherein said chamber central portion has an angular extension θₐ being in a ratio θₐ/θ equal to or greater than 0.25 with the angle θ comprised between said chamber arm portions.

29. The optical analysis disc according to claim 26 wherein said analysis zone comprises at least a liquid-containing channel extending according a substantially circumferential path and wherein the radius of curvature of said channel r_{c} and the length of the column of liquid b contained within said channel are in a ratio r_{c}/b equal to or greater than 0.5.

30. The optical analysis disc according to claim 29 wherein said ratio r_{c}/b is equal to or greater than 1.

31. The optical analysis disc according to claim 26 comprising two inlet ports located at a lower radial coordinate of the bio-disc with respect to said analysis zone.

32. The optical analysis disc according to claim 27 comprising two inlet ports located each at one end of a respective lateral arm portion of said at least one fluid chamber.

33. The optical analysis disc according to claim 26 wherein said at least one fluid chamber is a fluid channel.

34. The optical analysis disc according to claim 33 further comprising a plurality of analysis fluid channels extending according to a varying angular coordinate.

35. The optical analysis disc according to claim 34 further comprising multiple tiers of analysis fluid channels.

36. The optical analysis disc according to claim 35 further comprising two tiers of circumferential fluid channels with ABO chemistry and two different blood types.

37. The optical analysis disc according to claim 35 further comprising two tiers of circumferential fluid channels with two different assays.

38. The optical analysis disc according to claim 37 wherein said two assays comprises CD4/CD8 chemistry and ABO/RH chemistry.

39. The optical analysis disc according to claim 34 wherein the fluid channels of said plurality are arranged at substantially the same radial coordinate.

40. The optical analysis disc according to claim 39 further comprising six circumferential analysis fluid channels arranged at substantially the same radial coordinate.

41. The optical analysis disc according to claim 39 further comprising four circumferential analysis fluid channels arranged at substantially the same radial coordinate.

42. The optical analysis disc according to claim 34 wherein the fluid channels of said plurality include different concentrations of cultured cells.

43. The optical analysis disc according to claim 34 wherein the fluid channels of said plurality are arranged at different radial coordinates.

44. The optical analysis disc according to claim 34 wherein the fluid channels of said plurality have different sizes.

45. The optical analysis disc according to claim 10 implemented in a reflective-type optical bio-disc.

46. The optical analysis disc according to claim 10 implemented in a transmissive-type optical bio-disc.

47. The optical analysis disc according to claim 10 wherein rotation of said disc distributes investigational features in a substantially consistent distribution along said analysis zone.

48. The optical analysis disc according to claim 10 wherein rotation of said bio-disc distributes the concentration of investigational features in a substantially even distribution along said analysis zone.

49. An optical analysis disc, comprising:
a substrate having an inner perimeter and an outer perimeter; and
an analysis zone including investigational features and positioned between said inner perimeter and said outer perimeter of said substrate, said analysis zone including at least one liquid-containing channel having at least a portion which extends along a substantially circumferential path, the radius of curvature of said channel circumferential portion r_{c} and the length of the column of liquid b contained within said channel being in a ratio r_{c}/b equal to or greater than 0.5.

50. The optical analysis disc according to claim 49 wherein said ratio r_{c}/b is equal to or greater than 1.

51. The optical analysis disc according to claim 49 implemented in a reflective-type optical bio-disc.

52. The optical analysis disc according to claim 49 implemented in a transmissive-type optical bio-disc.

53. An optical analysis disc system for use with an optical analysis bio-disc having an analysis zone including investigational features, said system comprising interrogation means adapted to interrogate said investigational features according to a varying angular coordinate.

54. An optical analysis disc system for use with an optical analysis disc having information tracks and an analysis zone including investigational features, wherein said system comprises interrogation means such that when an incident beam of electromagnetic energy tracks along said information tracks, any investigational features within the analysis zone are thereby interrogated circumferentially.

55. The optical analysis disc system according to claim 53 wherein said interrogation means are adapted to interrogate the investigational features according to a varying angular coordinate at a substantially fixed radial coordinate.

56. The optical analysis disc system according to claim 53 wherein said interrogation means are adapted to interrogate the investigational features according to a varying angular and radial coordinate.

57. The optical analysis disc system according to claim 53 wherein said interrogation means are adapted to interrogate the investigational features according to a spiral path.

58. The optical analysis disc system according to claim 53 wherein said interrogation means are adapted to interrogate the investigational features according to a substantially circumferential path.

59. The optical analysis disc system according to claim 53 wherein said interrogation means are adapted to interrogate investigational features at a plurality of reaction sites arranged according to a varying angular coordinate.

60. The optical analysis disc system according to claim 53 wherein said interrogation means are adapted to interrogate investigational features at a plurality of capture zones or target zones arranged according to a varying angular coordinate.

61. The optical analysis disc system according to claim 53 wherein said interrogation means are adapted to interrogate investigational features at a plurality of analysis zones at least one of which is directed along a varying angular coordinate.

62. The optical analysis disc system according to claim 61 wherein said interrogation means are adapted to interrogate investigational features at multiple tiers of analysis zones.

63. The optical analysis disc system according to claim 53 wherein said interrogation means are adapted to interrogate investigational features within at least one fluid chamber extending according to a varying angular coordinate.

64. The optical analysis disc system according to claim 63 wherein said interrogation means are adapted to interrogate investigational features within a plurality of fluid chambers.

65. The optical analysis disc system according to claim 64 wherein said interrogation means are adapted to interrogate investigational features within multiple tiers of fluid chambers.

66. The optical analysis disc system according to claim 64 wherein said interrogation means are adapted to interrogate investigational features within a plurality of substantially circumferential fluid chambers arranged at substantially the same radial coordinate.

67. The optical analysis disc system according to claim 64 wherein said interrogation means are adapted to interrogate investigational features within fluid chambers arranged at different radial coordinates.

68. The optical analysis disc system according to claim 64 wherein said interrogation means are adapted to interrogate investigational features within fluid chambers of different sizes.

69. The optical analysis disc system according to claim 64 wherein said interrogation means are adapted to interrogate investigational features within fluid chambers with ABO chemistry and two blood types.

70. The optical analysis disc system according to claim 64 wherein said interrogation means are adapted to interrogate investigational features within fluid chambers with different assays.

71. The optical analysis disc system according to claim 64 wherein said interrogation means are adapted to interrogate investigational features within fluid channels with CD4/CD8 chemistry and ABO/RH chemistry.

72. The optical analysis disc system according to claim 64 wherein said interrogation means are adapted to interrogate investigational features within fluid chambers including different concentrations of cultured cells.

73. The optical analysis disc system according to claim 53 wherein the arrangement is such that rotation of the bio-disc distributes investigational features in a substantially consistent distribution along the analysis zone.

74. The optical analysis disc system according to claim 53 wherein the arrangement is such that rotation of the bio-disc distributes investigational features in a substantially even distribution along the analysis zone.

75. The optical analysis disc system according to claim 53 wherein said optical analysis disc is implemented in a reflective-type optical bio-disc.

76. The optical analysis disc system according to claim 53 wherein said optical analysis disc is implemented in a transmissive-type optical bio-disc.

77. A method for the interrogation of investigational features within an optical analysis bio-disc having an analysis zone including said features, which method provides interrogation of said features according to a varying angular coordinate.

78. A method for the interrogation of investigational features within an optical analysis disc having information tracks and an analysis zone including said features, which method provides an interrogation step of said investigational features such that when an incident beam of electromagnetic energy tracks along said information tracks, any investigational features within the analysis zone are thereby interrogated circumferentially.

79. The method according to claim 77 wherein said interrogation step provides interrogation of the investigational features according to a varying angular coordinate at a substantially fixed radial coordinate.

80. The method according to claim 77 wherein said interrogation step provides interrogation of the investigational features according to a varying angular and radial coordinate.

81. The method according to claim 77 wherein said interrogation step provides interrogation of the investigational features according to a spiral path.

82. The method according to claim 77 wherein said interrogation step provides interrogation of the investigational features according to a substantially circumferential path.

83. The method according to claim 77 wherein said interrogation step provides interrogation of investigational features at a plurality of reaction sites arranged according to a varying angular coordinate.

84. The method according to claim 77 wherein said interrogation step provides interrogation of investigational features at a plurality of capture zones or target zones arranged according to a varying angular coordinate.

85. The method according to claim 77 wherein said interrogation step provides interrogation of investigational features at a plurality of analysis zones at least one of which extends according to a varying angular coordinate.

86. The method according to claim 85 wherein said interrogation step provides interrogation of investigational features at multiple tiers of analysis zones.

87. The method according to claim 77 wherein said interrogation step provides interrogation of investigational features within at least one fluid chamber extending according to a varying angular coordinate.

88. The method according to claim 87 wherein said interrogation step provides interrogation of investigational features within a plurality of fluid chambers.

89. The method according to claim 88 wherein said interrogation step provides interrogation of investigational features within multiple tiers of fluid chambers.

90. The method according to claim 88 wherein said interrogation step provides interrogation of investigational features within a plurality of circumferential fluid chambers arranged at substantially the same radial coordinate.

91. The method according to claim 88 wherein said interrogation step provides interrogation of investigational features within fluid chambers arranged at different radial coordinates.

92. The method according to claim 88 wherein said interrogation step provides interrogation of investigational features within fluid chambers of different sizes.

93. The method according to claim 88 wherein said interrogation step provides interrogation of investigational features within fluid chambers with different assays.

94. The method according to claim 88 wherein said interrogation step provides interrogation of investigational features within fluid chambers including different concentrations of cultured cells.

95. The method according to claim 77 wherein rotation of the bio-disc distributes investigational features in a substantially consistent distribution along the analysis zone.

96. The method according to claim 77 wherein rotation of the bio-disc distributes investigational features in a substantially even distribution along the analysis zone.
